(19) United States
(12) Patent Application Publication
(10) Pub. No.: US 2013/0071656 A1
(43) Pub. Date: Mar. 21, 2013

(54) PEELABLE PRESSURE-SENSITIVE ADHESIVE COMPOSITION, PEELABLE PRESSURE-SENSITIVE ADHESIVE LAYER, AND PEELABLE PRESSURE-SENSITIVE ADHESIVE SHEET

(71) Applicants: Masato YAMAGATA, Osaka (JP); Masayuki OKAMOTO, Osaka (JP); Kiyoe SHIGETOMI, Osaka (JP)

(72) Inventors: Masato YAMAGATA, Osaka (JP); Masayuki OKAMOTO, Osaka (JP); Kiyoe SHIGETOMI, Osaka (JP)

(73) Assignee: NITTO DENKO CORPORATION, Osaka (JP)

(21) Appl. No.: 13/619,035

(22) Filed: Sep. 14, 2012

(30) Foreign Application Priority Data
Sep. 20, 2011 (JP) 2011-204693
Jun. 19, 2012 (JP) 2012-138240

(51) Int. Cl. C09J 133/02; C09J 7/02

(52) U.S. Cl. 428/355 AC; 525/210; 525/216; 525/221

(57) ABSTRACT

A peelable pressure-sensitive adhesive composition includes: 100 parts by mass of a polymer (A) having a glass transition temperature lower than 0° C.; and 0.05 parts by mass to 3 parts by mass of a (meth)acrylic polymer (B) that has a weight average molecular weight of 1000 or more and less than 30000 and that contains, as a monomer unit, a (meth)acrylic monomer having an alicyclic structure represented by the following general formula (1):

CH₂═C(R¹)COOR² (1)

[wherein, R¹ is a hydrogen atom or methyl group and R² is an alicyclic hydrocarbon group having an alicyclic structure].

### BACKGROUND OF THE INVENTION

1. Field of the Invention

The present invention relates to a peelable pressure-sensitive adhesive composition, a peelable pressure-sensitive adhesive layer having the composition, and a peelable pressure-sensitive adhesive sheet. A peelable pressure-sensitive adhesive sheet according to the present invention can be used, for example, as a surface protective sheet that protects the surface of an adherend when being attached to the adherend and can be easily peeled off after being used. Among its applications, the peelable pressure-sensitive adhesive sheet can be used as an optical surface protective sheet to be used for protecting the surface of an optical member, such as a polarizing plate, wavelength plate, optical compensation film, reflective sheet, or the like; and can also be used as an optical film with a surface protective sheet in which an optical surface protective film is attached to the optical member.

2. Description of the Related Art

A peelable pressure-sensitive adhesive sheet that will be peeled off after being attached to an adherend for a certain period of time is known. For example, a surface protective sheet is used for preventing the occurrence of scratches and stains in an object to be protected, which may be created while the object is being processed or transported, by being attached to the object via the pressure-sensitive adhesive generally coated on the surface protective sheet side. The surface protective sheet is peeled off (peeled off again) and removed when the sheet becomes unnecessary. As the objects to be protected, stainless steel products, plastic products, and glass plates, etc., are known. In recent years, surface protective sheets (optical surface protective sheets) are attached to optical members (optical films) for preventing the occurrence of scratches and stains therein, the optical members (optical films) being to be attached to the liquid crystal cells of liquid crystal displays.

As stated above, a surface protective sheet is peeled off and removed when it becomes unnecessary; and in this case, the sheet is mostly peeled off at relatively high speed from the viewpoint of work efficiency. Accordingly, there has been the problem that, if the pressure-sensitive adhesive force occurring at high-speed peeling is large, work efficiency is decreased and an object to be protected, such as an optical member, glass, or the like, may be damaged while the sheet is being peeled off. On the other hand, when the pressure-sensitive adhesive force occurring at high-speed peeling is made to be sufficiently small, there has sometimes been the problem that the pressure-sensitive adhesive force occurring at low-speed peeling is also decreased and lifting and unintended separation of the sheet may be created after the punching process of an object to be protected or the grinding process of the end surface of the object. In addition, when a surface protective sheet is used for protecting the surface of an optical member, there are sometimes the cases where inspection of an adherend is performed while the surface protective sheet is being attached thereto; and accordingly, there is a demand that the surface protective sheet itself has high transparency.

In response to such a demand, as a surface protective sheet that is good in high-speed peeling property, that does not cause zipping, that does not contaminate an adherend after being peeled off, and that has a small change in the peeling force depending on peeling speed, a surface protective sheet that is obtained by coating, on a supporting body, a pressure-sensitive adhesive for protective sheet, in which a (meth)acrylic polymer having a glass transition temperature lower than or equal to a certain value and a (meth)acrylic polymer having a glass transition temperature higher than or equal to a certain value have been compounded together and they have been cross-linked together such that the gel fraction is more than or equal to a certain value, has been presented (see Patent Document 1). However, there have sometimes been the cases where the adhesiveness occurring at low-speed peeling is deteriorated, and in particular, the transparency has not been at a satisfactory level.

### Patent Document

[Patent Document 1] Japanese Patent Application Publication No. 2005-146151

### SUMMARY OF THE INVENTION

Accordingly, there is a demand for a peelable pressure-sensitive adhesive sheet that has small pressure-sensitive adhesive force occurring at high-speed peeling, that has adhesive force occurring at low-speed peeling so large as not to cause a problem, such as lifting and unintended separation, and in particular, that has high transparency.

An embodiment of the present invention is a peelable pressure-sensitive adhesive composition. The peelable pressure-sensitive adhesive composition comprises: 100 parts by mass of a polymer (A) having a glass transition temperature lower than 0° C.; and 0.05 parts by mass to 3 parts by mass of a (meth)acrylic polymer (B) that has a weight average molecular weight of 1000 or more and less than 30000 and that contains, as a monomer unit, a (meth)acrylic monomer having an alicyclic structure represented by the following general formula (I):

CH₂═C(R¹)COOR² (1)

[wherein, R¹ is a hydrogen atom or methyl group and R² is an alicyclic hydrocarbon group having an alicyclic structure].

In the pressure-sensitive adhesive for protective sheet described in Patent Document 1, it is disclosed that 5 to 20 parts by mass of a (meth)acrylic polymer having a glass transition temperature of 80° C. or higher, which is preferably represented by a C₁₋₄ methacrylic acid alkyl ester, such as methyl methacrylate, is compounded into 100 parts by mass of a (meth)acrylic polymer having a glass transition temperature of −40° C. or lower. If 5 parts by mass or more of a (meth)acrylic polymer having a high glass transition temperature is compounded into a (meth)acrylic polymer having a low glass transition temperature, the transparency is remarkably deteriorated. Accordingly, 0.05 parts by mass to 3 parts by mass of the (meth)acrylic polymer (B) that has a weight average molecular weight of 1000 or more and less than 30000 and that contains, as a monomer unit, a (meth)acrylic monomer particularly having an alicyclic structure is compounded into 100 parts by mass of the polymer (A) having a glass transition temperature lower than 0° C. Thereby, the effects that the pressure-sensitive adhesive force occurring at high-speed peeling is small and that the adhesive force occurring at low-speed peeling is sufficiently so large as not to cause a problem, such as lifting and unintended separation, can be exerted while the transparency is being secured.

In the peelable pressure-sensitive adhesive composition according to the aforementioned embodiment, the polymer (A) may be an acrylic polymer.

In the peelable pressure-sensitive adhesive composition according to the aforementioned embodiment, the alicyclic hydrocarbon group having an alicyclic structure, in the (meth)acrylic polymer (B), may have a bridged ring structure. In addition, the glass transition temperature of the (meth)acrylic polymer (B) may be within a range of 20° C. to 300° C.

Another embodiment of the present invention is a peelable pressure-sensitive adhesive layer. The peelable pressure-sensitive adhesive layer is made of the peelable pressure-sensitive adhesive composition according to any one of the aforementioned embodiments. The peelable pressure-sensitive adhesive layer according to the present embodiment may contain 85.00% by mass to 99.95% by mass of a solvent-insoluble component.

Still another embodiment of the present invention is a peelable pressure-sensitive adhesive sheet. The peelable pressure-sensitive adhesive sheet contains the peelable pressure-sensitive adhesive layer according to any one of the aforementioned embodiments.

In the peelable pressure-sensitive adhesive sheet according to the above embodiment, a supporting body may be a plastic substrate on which an antistatic treatment is performed.

Still another embodiment of the present invention is a surface protective sheet. The surface protective sheet contains the peelable pressure-sensitive adhesive sheet according to any one of the aforementioned embodiments.

The present invention further includes: an optical surface sheet in which the surface protective sheet is used for protecting the surface of an optical film; and an optical film with a surface protective sheet to which the optical surface protective sheet is attached.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a schematic side view explaining a low-speed peeling test (constant load peeling) according to an example of the present invention; and

FIG. 2 is a schematic side view explaining a high-speed peeling test (180° peeling-off pressure-sensitive adhesive force) according to an example of the present invention.

### DETAILED DESCRIPTION OF THE INVENTION

The invention will now be described by reference to the preferred embodiments. This does not intend to limit the scope of the present invention, but to exemplify the invention.

A peelable pressure-sensitive adhesive composition according to an embodiment comprises, as pressure-sensitive adhesive compositions: 100 parts by mass of a polymer (A) having a glass transition temperature lower than 0° C.; and 0.05 parts by mass to 3 parts by mass of a (meth)acrylic polymer (B) that has a weight average molecular weight of 1000 or more and less than 30000 and that contains, as a monomer unit, a (meth)acrylic monomer having an alicyclic structure represented by the following general formula (I) (hereinafter, appropriately referred to as the (meth)acrylic polymer (B)):

CH₂═C(R¹)COOR² (1)

[wherein, R¹ is a hydrogen atom or methyl group and R² is an alicyclic hydrocarbon group having an alicyclic structure].

Hereinafter, the polymer (A) and the (meth)acrylic polymer (B), which are essential components in the peelable pressure-sensitive adhesive composition according to the present embodiment, will be described in detail.

### [Polymer (A)]

The polymer (A) is not particularly limited, as far as the glass transition temperature thereof is lower than 0° C., and various polymers to be generally used as pressure-sensitive adhesives, such as an acrylic polymer, rubber polymer, silicone polymer, polyurethane polymer, and polyester polymer, can be used. In particular, an acrylic polymer that is easily compatible with the (meth)acrylic polymer (B) and has high transparency is preferred.

The glass transition temperature (Tg) of the polymer (A) is lower than 0° C., and preferably lower than −10° C., and more preferably lower than −40° C., and usually higher than or equal to −80° C. If the glass transition temperature (Tg) of the polymer (A) is higher than or equal to 0° C., it becomes difficult for the polymer to flow and the wetting of an adherend becomes insufficient, thereby sometimes causing the cases where the adhesiveness is deteriorated.

When the polymer (A) is a copolymer in the present embodiment, the glass transition temperature thereof is a value calculated based on Equation (2) (Fox Equation).

1/Tg=W1/Tg1+W2/Tg2+ * * * +Wn/Tgn (2)

[wherein, Tg represents the glass transition temperature of the copolymer (unit: K), Tgi (i=1, 2, * * * , n) represents the glass transition temperature of a homopolymer that is formed of a monomer i (unit: K), and Wi (i=1, 2, * * * , n) represents the mass fraction of the monomer i in the whole monomer components].

The glass transition temperature Tgi of the monomer is a nominal value described in documents (e.g., POLYMER HANDBOOK, PRESSURE-SENSITIVE ADHESIVE HANDBOOK, etc.) or catalogs, etc.

Herein, the “glass transition temperature of a homopolymer that is formed” means the “glass transition temperature of a homopolymer formed of the monomer”, i.e., means the glass transition temperature (Tg) of a polymer that is formed only of a monomer (sometimes referred to as a “monomer X”) as a monomer component. Specifically, the glass transition temperature (Tg) is described in “Polymer Handbook” (3rd edition, John Wiley & Sons, Inc, 1989). The glass transition temperature (Tg) of a homopolymer, which is not described in the aforementioned document, means a value obtained, for example, by the following method. That is, after 100 parts by mass of a monomer X, 0.2 parts by mass of 2,2′-azobisisobutyronitrile, and 200 parts by mass of ethyl acetate as a polymerization solvent are placed into a reactor provided with a thermometer, stirrer, nitrogen inlet pipe, and reflux cooling pipe, they are stirred for 1 hour while nitrogen gas is being introduced. After the oxygen in the polymerization system has been removed in such a way, the mixture is heated to 63° C. and is reacted together for 10 hours. Subsequently, the mixture is cooled to room temperature to obtain a homopolymer solution having a solid content of 33% by mass. Subsequently, this homopolymer solution is casted and coated onto a release liner, which is then dried to produce a test sample having a thickness of approximately 2 mm (sheet-shaped homopolymer). Approximately 1 to 2 mg of this test sample are weighed into an aluminum open cell, and the Reversing Heat Flow (specific heat component) behaviors of the homopolymer are obtained by using a temperature-modulated DSC (product name: “Q-2000”, made by TA Instruments) under a nitrogen environment of 50 ml/min and at a rate of temperature increase of 5° C./min. With reference to JIS-K-7121, the temperature at the point where the straight line, which is located in the vertical axis direction at the same distance from both the straight line obtained by extending the base line on the low temperature side of the obtained Reversing Heat Flow and the straight line obtained by extending the base line on the high temperature side thereof, and the curved line in a portion where the glass transition temperature is changed in a stepwise pattern intersect with each other is made to be the glass transition temperature (Tg), assuming that it is a homopolymer.

The weight average molecular weight (Mw) of the polymer (A) is, for example, within a range of 30,000 to 5,000,000, and preferably within a range of 100,000 to 2,000,000, and more preferably within a range of 200,000 to 1,000,000. If the weight average molecular weight (Mw) is less than 30,000, the cohesive force of the pressure-sensitive adhesive becomes insufficient and there are sometimes the cases where an adherend is likely to be contaminated. On the other hand, if the weight average molecular weight (Mw) is more than 5,000,000, the flowability of the pressure-sensitive adhesive becomes low and there are sometimes the cases where the wetting of an adherend becomes insufficient and the adhesiveness is deteriorated.

Hereinafter, an acrylic polymer, which is a preferred and specific example of the polymer (A), will be described.

The acrylic polymer is a polymer that contains, as a monomer unit, (meth)acrylic acid alkyl ester having, for example, a C₁₋₂₀ linear or branched alkyl group in an amount of 50% by mass or more. In addition, the acrylic polymer may have a structure formed only by (meth)acrylic acid alkyl ester having a C₁₋₂₀ alkyl group or by a combination of two or more thereof. A method of obtaining the acrylic polymer is not particularly limited, and the polymer can be obtained by using various polymerization methods that are generally used as techniques for synthesizing an acrylic polymer, such as solution polymerization, emulsion polymerization, bulk polymerization, suspension polymerization, and radiation curing polymerization, etc. When the peelable pressure-sensitive adhesive sheet according to the present embodiment is used as the later-described surface protective sheet, solution polymerization and emulsion polymerization can be preferably used.

The ratio of the (meth)acrylic acid alkyl ester having a C₁₋₂₀ alkyl group is, for example, within a range of 50% by mass to 99.9% by mass, preferably within a range of 60% by mass to 98% by mass, and more preferably within a range of 70% by mass to 95% by mass, based on the total mass of the monomer components for preparing the acrylic polymer.

Examples of the (meth)acrylic acid alkyl ester having a C₁₋₂₀ alkyl group include, for example: (meth)acrylic acid C₁₋₂₀ alkyl esters [preferably (meth)acrylic acid C₂₋₁₄ alkyl esters, more preferably (meth)acrylic acid C₂₋₁₀ alkyl esters], such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl. In addition, the “(meth)acrylic acid alkyl ester” means an acrylic acid alkyl ester and/or a methacrylic acid alkyl ester, and all of the “(meth).” expressions have the same meaning.

For the purpose of modifying cohesive force, heat resistance, and cross-linking property, etc., the acrylic polymer may contain, if necessary, another monomer component (copolymerizable monomer) that is copolymerizable with the (meth)acrylic acid alkyl ester. Accordingly, the acrylic polymer may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxy pentyl acrylate, itaconic acid, maleic acid, fumaric acid, crotonic acid, and isocrotonic acid; hydroxyl group-containing monomers, such as (meth)acrylic acid hydroxyalkyls including (meth)acrylic acid 2-hydroxyethyl, (meth)acrylic acid 3-hydroxypropyl, (meth)acrylic acid 4-hydroxybutyl, (meth)acrylic acid 6-hydroxyhexyl, (meth)acrylic acid 8-hydroxyoctyl, (meth)acrylic acid 10-hydroxydecyl, (meth)acrylic acid 12-hydroxylauryl, and (4-hydroxymethyl cyclohexyl)methyl methacrylate; acid anhydride group-containing monomers, such as maleic acid anhydride and itaconic acid anhydride; sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphate group-containing monomers, such as 2-hydroxyethyl acryloyl phosphate; (N-substituted)amide monomers, such as N,N-dialkyl(meth)acrylamides including (meth)acrylamide, N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide, N-ethyl(meth)acrylamide, N-isopropyl(meth)acrylamide, N-butyl(meth)acrylamide, N-n-butyl(meth)acrylamide, N-methylol(meth)acrylamide, N-ethylol (meth)acrylamide, N-methylol propane (meth)acrylamide, N-methoxymethyl(meth)acrylamide, N-methoxyethyl(meth)acrylamide, N-butoxymethyl(meth)acrylamide, and N-acryloylmorpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexylmaleimide, N-isopropylmaleimide, N-laurylmaleimide, and N-phenylmaleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinyl-2-piperidone, N-vinyl-3-morpholine, N-vinyl-2-caprolactam, N-vinyl-1,3-oxazine-2-one, N-vinyl-3,5-morpholine dione; N-vinylpyrazole, N-vinyl isoxazole, N-vinylthiazole, N-vinylisothiazole, and N-vinylpyridazine; N-vinyl carboxylic acid amides; lactam monomers, such as N-vinyl caprolactam; cyanoacrylate monomers, such as acrylonitrile and methacrylonitrile; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; styrene monomers, such as styrene and α-methylstyrene; epoxy group-containing acrylic monomers, such as (meth)acrylic acid glycidyl; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; vinyl esters, such as vinyl acetate and vinyl propionate aromatic vinyl compounds, such as vinyl toluene and styrene; olefins or dienes, such as ethylene, butadiene, isoprene, and isobutylene; vinyl ethers, such as vinyl alkyl ether; vinyl chloride; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; acryloyl morpholine; (meth)acrylic acid esters having an alicyclic hydrocarbon group, such as cyclopentyl(meth)acrylate, cyclohexyl(meth)acrylate, isobornyl(meth)acrylate, and dicyclopentanil(meth)acrylate; (meth)acrylic acid esters having an aromatic hydrocarbon group, such as phenyl(meth)acrylate and phenoxyethyl(meth)acrylate; and (meth)acrylic acid esters obtained from terpene compound derivative alcohols. These copolymerizable monomers can be used alone or in combination of two or more thereof.

When the acrylic polymer contains a copolymerizable monomer along with the (meth)acrylic acid alkyl ester as a major component, hydroxyl group-containing monomers or carboxyl group-containing monomers can be preferably used. Among them, (meth)acrylic acid 2-hydroxyethyl and (meth)acrylic acid 4-hydroxybutyl as the hydroxyl group-containing monomer or an acrylic acid as the carboxyl group-containing monomer can be preferably used. The use amount of the copolymerizable monomer is not particularly limited, but the copolymerizable monomer can be usually contained in an amount within a range of 0.01% by mass to 40% by mass, preferably within a range of 0.1% by mass to 30% by mass, and more preferably within a range of 0.5% by mass to 20% by mass, based on the total mass of the monomer components for preparing the acrylic polymer.

By containing the copolymerizable monomer in an amount of 0.01% by mass or more, a decrease in the cohesive force of the acrylic pressure-sensitive adhesive sheet having a pressure-sensitive adhesive layer formed of the acrylic pressure-sensitive adhesive composition can be prevented, and accordingly the contamination possibly occurring when the sheet has been peeled off from an adherend can be prevented. Further, by containing the copolymerizable monomer in an amount of 40% by mass or less, it can be prevented that the cohesive force may become too large, and accordingly the tackiness at normal temperature (25° C.) can be improved.

A polyfunctional monomer may be contained, if necessary, in the acrylic polymer in order to adjust the cohesive force of the acrylic pressure-sensitive adhesive composition to be formed.

Examples of the polyfunctional monomer include, for example: (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyl di(meth)acrylate, and hexyl di(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof, but the polyfunctional monomer is added in an amount within a range of 0.01% by mass to 3.0% by mass, preferably within a range of 0.02% by mass to 2.0% by mass, and more preferably within a range of 0.03% by mass to 1.0% by mass, based on the total mass of the monomer components for preparing the acrylic polymer.

If the use amount of the polyfunctional monomer is more than 3.0% by mass based on the total mass of the monomer components for preparing the acrylic polymer, for example, the cohesive force of the acrylic pressure-sensitive adhesive composition becomes too large, and accordingly there are sometimes the cases where the adhesive force (high-speed peeling force, low-speed peeling force) is decreased. On the other hand, if the use amount thereof is less than 0.01% by mass, for example, the cohesive force of the acrylic pressure-sensitive adhesive composition is decreased, and accordingly there are sometimes the cases where the sheet is contaminated when being peeled off from an adherend (object to be protected).

In preparing the acrylic polymer, the acrylic polymer can be easily formed by a curing reaction using heat or ultraviolet rays with the use of a polymerization initiator, such as thermal polymerization initiator, photo-polymerization initiator (photo-initiator), or the like. In particular, a thermal polymerization initiator can be preferably used in terms of the advantage that a polymerization time can be shortened. The polymerization initiators can be used alone or in combination of two or more thereof.

Examples of the thermal polymerization initiator include, for example: azo polymerization initiators (for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl) propane]dihydrochloride, 2,2′-azobis(2-methylpropionamidine)disulfate, and 2,2′-azobis(N,N′-dimethyleneisobutylamidine)dihydrochloride, etc.); peroxide polymerization initiators (for example, dibenzoyl peroxide, t-butyl permaleate, and lauroyl peroxide, etc.); and redox polymerization initiators, etc.

The use amount of the thermal polymerization initiator is not particularly limited, but is compounded, for example, in an amount within a range of 0.01 parts by mass to 5 parts by mass, and preferably within a range of 0.05 parts by mass to 3 parts by mass, based on 100 parts by mass of the monomer components for preparing the acrylic monomer.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651, made by BASF], and anisole methyl ether, etc. Specific examples of the acetophenone photo-polymerization initiator include, for example: 1-hydroxycyclohexyl phenyl ketone [product name: IRGACURE 184, made by BASF], 4-phenoxydichloroacetophenone, 4-t-butyl-dichloroacetophenone, 1-[4-(2-hydroxyethoxy)-phenyl]-2-hydroxy-2-methyl-1-propane-1-one [product name: IRGACURE 2959, made by BASF], 2-hydroxy-2-methyl-1-phenyl-propane-1-one [product name: DAROCUR 1173, made by BASF], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,1-propanedione-2-(o-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl) phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl) phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl) phosphine oxide, bis(2,6-dibutoxybenzoyl)(2-methylpropane-1-yl) phosphine oxide, bis(2,4-dimethoxybenzoyl)(2-methypropane-1-yl) phosphine oxide, bis(2,4,6-trimethylbenzoyl)(2,4-dipentoxyphenyl) phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

The use amount of the photo-polymerization initiator is not particularly limited, but the photo-polymerization initiator is compounded, for example, in an amount within a range of 0.01 parts by mass to 5 parts by mass, and preferably within a range of 0.05 parts by mass to 3 parts by mass, based on 100 parts by mass of the monomer components for preparing the acrylic polymer.

If the use amount of the photo-polymerization initiator is less than 0.01 parts by mass, there are sometimes the cases where a polymerization reaction becomes insufficient. If the use amount thereof is more than 5 parts by mass, there are sometimes the cases where an ultraviolet ray does not reach the inside of the pressure-sensitive adhesive layer, because the photo-polymerization initiator absorbs an ultraviolet ray. In this case, a decrease in the rate of polymerization is caused, or the molecular weight of the generated polymer becomes small. Thereby, the cohesive force of the formed pressure-sensitive adhesive layer becomes small, and hence there are sometimes the cases where, when the pressure-sensitive adhesive layer is peeled off from a film, part of the pressure-sensitive adhesive layer remains on the film and accordingly the film cannot be reused. The photo-polymerization initiators may be used alone or in combination of two or more thereof.

In the present embodiment, the acrylic polymer can also be prepared as a partial polymer (acrylic polymer syrup) that can be obtained by radiating ultraviolet (UV) rays onto a mixture in which the aforementioned monomer components and the polymerization initiator have been compounded, so that the monomer components are partially polymerized. An acrylic pressure-sensitive adhesive composition is prepared by combining the later-described (meth)acrylic polymer (B) into the acrylic polymer syrup, and then polymerization can also be completed by coating the pressure-sensitive adhesive composition on a predetermined object to be coated and by radiating UV rays.

The weight average molecular weight (Mw) of the acrylic polymer is, for example, within a range of 30,000 to 5,000,000, preferably within a range of 100,000 to 2,000,000, and more preferably within a range of 200,000 to 1,000,000. If the weight average molecular weight (Mw) is smaller than the aforementioned range, the cohesive force of the pressure-sensitive adhesive becomes insufficient and there are sometimes the cases where an adherend is likely to be contaminated. On the other hand, if the weight average molecular weight (Mw) is larger than the aforementioned range, the flowability of the pressure-sensitive adhesive becomes low and there are sometimes the cases where the wetting of an adherend becomes insufficient and the adhesiveness is deteriorated.

The glass transition temperature (Tg) of the acrylic polymer is lower than 0° C., and preferably lower than −10° C., and more preferably lower than −40° C., and usually higher than or equal to −80° C. If the glass transition temperature (Tg) of the acrylic polymer (A) is higher than or equal to 0° C., it becomes difficult for the polymer to flow and the wetting of an adherend becomes insufficient, thereby sometimes causing the cases where the adhesiveness is deteriorated.

When the acrylic polymer is a copolymer in the present embodiment, the glass transition temperature thereof is a value calculated based on the aforementioned Equation (2) (Fox Equation).

### [(Meth)Acrylic Polymer (B)]

The (meth)acrylic polymer (B) is a (meth)acrylic polymer that has a weight average molecular weight of 1000 or more and less than 30000 and that contains, as a monomer unit, a (meth)acrylic monomer having an alicyclic structure represented by the following general formula (1), and in the peelable acrylic pressure-sensitive adhesive composition according to the present embodiment, the (meth)acrylic polymer (B) functions as a tackifying resin:

CH₂═C(R¹)COOR² (1)

[wherein, R¹ is a hydrogen atom or methyl group and R² is an alicyclic hydrocarbon group having an alicyclic structure].

As the alicyclic hydrocarbon group R² in the general formula (1), alicyclic hydrocarbon groups, etc., such as a cyclohexyl group, isobornyl group, and dicyclopentanyl group, can be exemplified. Examples of the (meth)acrylic acid ester having such an alicyclic hydrocarbon group include, for example, esters of (meth)acrylic acids, such as (meth)acrylic acid cyclohexyl having a cyclohexyl group, (meth)acrylic acid isobornyl having an isobornyl group, and (meth)acrylic acid dicyclopentanyl having a dicyclopentanyl group, with alicyclic alcohols. By providing, as a monomer unit, an acrylic monomer having a relatively bulky structure to the (meth)acrylic polymer (B), as stated above, the adhesiveness occurring at low-speed peeling can be improved.

In addition, it is preferable in the present embodiment that the alicyclic hydrocarbon group that forms the (meth)acrylic polymer (B) has a bridged ring structure. The bridged ring structure referres to a tricyclic or higher alicyclic structure. By providing a bulky structure, such as a bridged ring structure, to the (meth)acrylic polymer (B), the adhesiveness of the peelable acrylic pressure-sensitive adhesive composition (peeelable acrylic pressure-sensitive adhesive sheet) can be further improved. In particular, the adhesiveness occurring at low-speed peeling can be improved more remarkably.

Examples of the alicyclic hydrocarbon group R² having abridged ring structure include, for example, a dicyclopentanyl group represented by the following formula (3a), a dicyclopentenyl group represented by the following formula (3b), an adamantyl group represented by the following formula (3c), a tricyclopentanyl group represented by the following formula (3d), and a tricyclopentenyl group represented by the following formula (3e), etc. Among the (meth)acrylic monomers having a tricyclic or higher alicyclic structure containing a bridged ring structure, (meth)acrylic monomers having a saturated structure, such as the dicyclopentanyl group represented by the following formula (3a), the adamantyl group represented by the following formula (3c), and the tricyclopentanyl group represented by the following formula (3d), can be particularly and preferably used as a monomer that forms the (meth)acrylic polymer (B), in terms of hardly causing inhibition of polymerization, when UV polymerization is adopted in synthesizing the (meth)acrylic polymer (B) or in producing the pressure-sensitive adhesive composition.

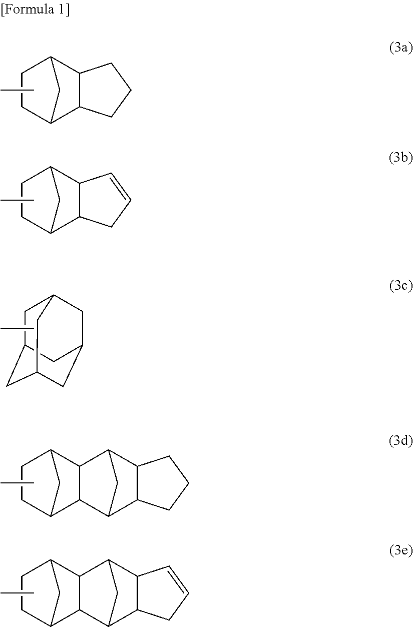

Examples of the (meth)acrylic monomer having such a tricyclic or higher alicyclic structure containing abridged ring structure include (meth)acrylic acid esters, such as dicyclopentanyl methacrylate, dicyclopentanyl acrylate, dicyclopentanyl oxyethyl methacrylate, dicyclopentanyl oxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. These (meth)acrylic monomers can be used alone or in combination of two or more thereof.

The (meth)acrylic polymer (B) according to the present embodiment may be a homopolymer of a (meth)acrylic monomer having an alicyclic structure, alternatively may be a copolymer of a (meth)acrylic monomer having an alicyclic structure and another (meth)acrylic acid ester monomer or a copolymerizable monomer.

Examples of the another (meth)acrylic acid ester include: (meth)acrylic acid alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid-2-ethylhexyl, (meth)acrylic acid heptyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, and (meth)acrylic acid dodecyl; (meth)acrylic acid aryl esters, such as (meth)acrylic acid phenyl and (meth)acrylic acid benzyl; and (meth)acrylic acid esters obtained from terpene compound derivative alcohols. These (meth)acrylic acid esters can be used alone or in combination of two or more thereof.

Examples of the copolymerizable monomer include: carboxyl group-containing monomers, such as acrylic acid, methacrylic acid, carboxy ethyl acrylate, carboxy pentyl acrylate, itaconic acid, maleic acid, fumaric acid, crotonic acid, and isocrotonic acid; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; salts, such as (meth)acrylic acid alkali metal salt; di(meth)acrylic acid ester monomers of (poly)alkylene glycol, such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol; di(meth)acrylic acid ester of propylene glycol, di(meth)acrylic acid ester of dipropylene glycol, and di(meth)acrylic acid ester of tripropylene glycol; poly(meth)acrylic acid ester monomers, such as trimethylolpropane tri(meth)acrylic acid ester; vinyl esters, such as vinyl acetate and vinyl propionate; halogenated vinyl compounds, such as vinylidene chloride and (meth)acrylic acid-2-chloroethyl; oxazoline group-containing polymerizable compounds, such as 2-vinyl-2-oxazoline, 2-vinyl-5-methyl-2-oxazoline, and 2-isopropenyl-2-oxazoline; aziridine group-containing polymerizable compounds, such as (meth)acryloylaziridine and (meth)acrylic acid-2-aziridinylethyl; epoxy group-containing vinyl monomers, such as allyl glycidyl ether, (meth)acrylic acid glycidyl ether and (meth)acrylic acid-2-ethyl glycidyl ether; hydroxyl group-containing vinyl monomers, such as (meth)acrylic acid-2-hydroxyethyl, (meth)acrylic acid-2-hydroxypropyl, and adducts of lactones with (meth)acrylic acid-2-hydroxyethyl; macro-monomers in which an unsaturated group, such as an acryloyl group, styryl group, vinyl group, or the like, is bonded to the end of polyalkylene glycol, such as polypropylene glycol, polyethylene glycol, a copolymer of polyethylene glycol and plypropylene glycol, and that of polybutylene glycol, and polyethylene glycol; fluorine-containing vinyl monomers, such as fluorine-substituted (meth)acrylic acid alkyl ester; acid anhydride group-containing monomers, such as maleic acid anhydride and itaconic acid anhydride; aromatic vinyl compound monomers, such as styrene, α-methylstyrene, and vinyl toluene; reactive halogen-containing vinyl monomers, such as 2-chloroethyl vinyl ether and monochloro vinyl acetate; amide group-containing vinyl monomers, such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexylmaleimide, N-isopropylmaleimide, N-laurylmaleimide, and N-phenylmaleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinylpyrazole, N-vinyl isoxazole, N-vinylthiazole, N-vinyl isothiazole, and N-vinylpyridazine; N-vinyl carboxylic acid amides; lactam monomers, such as N-vinyl caprolactam; cyanoacrylate monomers, such as (meth)acrylonitrile; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl; imide group-containing monomers, such as cyclohexyl maleimide and isopropyl maleimide; isocyanate group-containing monomers, such as 2-isocyanate ethyl(meth)acrylate; organic silicon-containing vinyl monomers, such as vinyltrimethoxysilane, γ-methacryloxpropyl trimethoxy silane, allyltrimethoxysilane, trimethoxysilylpropylallylamine, and 2-methoxy ethoxy trimethoxy silane; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; olefins or dienes, such as ethylene, butadiene, isoprene, and isobutylene; vinyl ethers, such as vinyl alkyl ether; vinyl chloride; and macro-monomers having a radically polymerizable vinyl group at the monomer end to which a vinyl group has been polymerized. These monomers can be polymerized, alone or in combination, with the aforementioned (meth)acrylic acid ester.

Examples of the (meth)acrylic polymer (B) according to the present embodiment include, for example, copolymer of cyclohexyl methacrylate (CHMA) and isobutyl methacrylate (IBMA), that of cyclohexyl methacrylate (CHMA) and isobornyl methacrylate (IBXMA), that of methyl methacrylate (MMA) and isobornyl methacrylate (IBXMA), that of cyclohexyl methacrylate (CHMA) and acryloyl morpholine (ACMO), that of cyclohexyl methacrylate (CHMA) and diethylacrylamide (DEAA), that of 1-adamantyl acrylate (ADA) and methyl methacrylate (MMA), that of dicyclopentanyl methacrylate (DCPMA) and isobornyl methacrylate (IBXMA), that of dicyclopentanyl methacrylate (DCPMA) and methyl methacrylate (MMA), that of dicyclopentanyl methacrylate (DCPMA) and N-vinyl-2-pyrrolidone (NVP), that of dicyclopentanyl methacrylate (DCPMA) and hydroxyethyl methacrylate (HEMA), that of dicyclopentanyl methacrylate (DCPMA) and acrylic acid (AA), homopolymer of dicyclopentanyl methacrylate (DCPMA), that of cyclohexyl methacrylate (CHMA), that of isobornyl methacrylate (IBXMA), that of isobornyl acrylate (IBXA), that of dicyclopentanyl acrylate (DCPA), that of 1-adamantyl methacrylate (ADMA), that of 1-adamantyl acrylate (ADA), and that of methyl methacrylate (MMA), etc.

A functional group reactive with an epoxy group or an isocyanate group may be further introduced into the (meth)acrylic polymer (B). Examples of such a functional group include a hydroxyl group, carboxyl group, amino group, amide group, and a mercapto group. When the (meth)acrylic polymer (B) is produced, it is preferable to use a monomer having such a functional group.

In the present embodiment, when a copolymer of a (meth)acrylic monomer having an alicyclic structure and another (meth)acrylic acid ester monomer or a copolymerizable monomer is used as the (meth)acrylic polymer (B), the content ratio of the (meth)acrylic monomer having an alicyclic structure is 5% by mass or more, preferably 10% by mass or more, more preferably 20% by mass or more, and still more preferably 30% by mass or more (usually less than 100% by mass, and preferably 90% by mass or less), in the whole monomers for forming the (meth)acrylic polymer (B). When 5% or more of a (meth)acrylic monomer having an alicyclic structure is contained, the pressure-sensitive adhesive force occurring at high-speed peeling can be made small and the adhesive force occurring at low-speed peeling can be improved to an extent where a problem, such as lifting and unintended separation, is not caused. If less than 5% by mass of a (meth)acrylic monomer having an alicyclic structure is contained, there are sometimes the cases where the adhesiveness, in particular, the adhesiveness occurring at low-speed peeling is deteriorated.

The weight average molecular weight of the (meth)acrylic polymer (B) is 1000 or more and less than 30000, preferably 1500 or more and less than 20000, and more preferably 2000 or more and less than 10000. If the weight average molecular weight is 30000 or more, the adhesiveness occurring at low-speed peeling is deteriorated. If the weight average molecular weight is less than 1000, that becomes too small, and hence a decrease in the pressure-sensitive adhesive force (high-speed peeling force, low-speed peeling force) of the pressure-sensitive adhesive sheet is caused.

The weight average molecular weight of the polymer (A) or (meth)acrylic polymer (B) can be determined by a gel permeation chromatography (GPC) method in terms of polystyrene. Specifically, the weight average molecular weight can be measured according to the method and conditions that are described in the later-described Examples.

The glass transition temperature (Tg) of the (meth)acrylic polymer (B) is within a range of 20° C. to 300° C., preferably within a range of 50° C. to 280° C., more preferably within a range of 90° C. to 280° C., and still more preferably within a range of 110° C. to 250° C. If the glass transition temperature (Tg) is lower than 20° C., there are sometimes the cases where the high-speed peeling force in which the pressure-sensitive adhesive force occurring at high-speed peeling is small and the low-speed peeling force in which the pressure-sensitive adhesive force occurring at low-speed peeling is sufficiently so large as not to cause a problem, such as lifting and unintended separation, are not compatible with each other.

The glass transition temperatures of typical materials that can be used as the (meth)acrylic polymer (B) in the present embodiment are shown in Table 1. The glass transition temperatures shown there are nominal values described in documents (POLYMER HANDBOOK, PRESSURE-SENSITIVE ADHESIVE HANDBOOK, etc.) or catalogs, etc., or when the (meth)acrylic polymer (B) is a copolymer, those are values calculated based on the aforementioned Equation (2) (Fox Equation).

TABLE 1

| COMPOSITION OF | | |
|---|---|---|
| (METH) ACRYLIC | | |
| POLYMER (B) | Tg(° C.) | REMARKS |
| DCPMA | 175 | VALUE DESCRIBED |
| | | IN DOCUMENTS, ETC. |
| DCPA | 120 | VALUE DESCRIBED |
| | | IN DOCUMENTS, ETC. |
| IBXMA | 173 | VALUE DESCRIBED |
| | | IN DOCUMENTS, ETC. |
| IBXA | 97 | VALUE DESCRIBED |
| | | IN DOCUMENTS, ETC. |
| CHMA | 66 | VALUE DESCRIBED |
| | | IN DOCUMENTS, ETC. |
| CHA | 15 | VALUE DESCRIBED |
| | | IN DOCUMENTS, ETC. |
| IBMA | 48 | VALUE DESCRIBED |
| | | IN DOCUMENTS, ETC. |
| MMA | 105 | VALUE DESCRIBED |
| | | IN DOCUMENTS, ETC. |
| ADMA | 250 | VALUE DESCRIBED |
| | | IN DOCUMENTS, ETC. |
| ADA | 153 | VALUE DESCRIBED |
| | | IN DOCUMENTS, ETC. |
| NVP | 54 | VALUE DESCRIBED |
| | | IN DOCUMENTS, ETC. |
| HEMA | 40 | VALUE DESCRIBED |
| | | IN DOCUMENTS, ETC. |
| DCPMA/MMA = 40/60 | 130 | CALCULATED VALUE |
| | | (BASED ON Fox EQUATION) |
| DCPMA/MMA = 60/40 | 144 | CALCULATED VALUE |
| | | (BASED ON Fox EQUATION) |
| DCPMA/MMA = 80/20 | 159 | CALCULATED VALUE |
| | | (BASED ON Fox EQUATION) |
| DCPMA/NVP = 60/40 | 117 | CALCULATED VALUE |
| | | (BASED ON Fox EQUATION) |
| DCPMA/HEMA = 60/40 | 139 | CALCULATED VALUE |
| | | (BASED ON Fox EQUATION) |
| IBXA/MMA = 40/60 | 130 | CALCULATED VALUE |
| | | (BASED ON Fox EQUATION) |
| CHMA/IBMA = 60/40 | 59 | CALCULATED VALUE |
| | | (BASED ON Fox EQUATION) |

The abbreviations in Table represent the following compounds.
DCPMA: Dicyclopentanyl Methacrylate
DCPA: Dicyclopentanil Acrylate
IBXMA: Isobornyl Methacrylate
IBXA: Isobornyl Acrylate
CHMA: Cyclohexyl Methacrylate
CHA: Cyclohexyl Acrylate
IBMA: Isobutyl Methacrylate
MMA: Methyl Methacrylate
ADMA: 1-Adamantyl Methacrylate
ADA: 1-Adamantyl Acrylate
NVP: N-vinyl-2-pyrrolidone
HEMA: Hydroxyethyl Methacrylate

The (meth)acrylic polymer (B) can be produced by subjecting (meth)acrylic monomers each having, for example, the aforementioned structure to polymerization with the use of a solution polymerization method, bulk polymerization method, emulsion polymerization method, suspension polymerization, block polymerization, or the like.

In order to adjust the molecular weight of the (meth)acrylic polymer (B), a chain transfer agent can be used while the polymer (B) is being polymerized. Examples of the chain transfer agent to be used include: compounds having a mercapt group, such as octylmercaptan, laurylmercaptan, t-dodecyl mercaptan, mercaptoethanol, and α-thioglycerol; thioglycolic acid, methyl thioglycolate, ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, and thioglycol acid esters, such as thioglycolic acid ester of ethylene glycol, thioglycolic acid ester of neopentyl glycol, and thioglycolic acid ester of pentaerythritol; and α-methylstyrenedimer, etc.

The use amount of the chain transfer agent is not particularly limited, but the chain transfer agent is usually contained in an amount within a range of 0.1 parts by mass to 20 parts by mass, preferably within a range of 0.2 parts by mass to 15 parts by mass, and more preferably within a range of 0.3 parts by mass to 10 parts by mass, based on 100 parts by mass of the (meth)acrylic polymer. By adjusting the addition amount of the chain transfer agent in such a way, a (meth)acrylic polymer (B) having a preferred molecular weight can be obtained. The chain transfer agent can be used alone or in combination of two or more thereof.

### [Peelable Pressure-Sensitive Adhesive Composition]

The peelable pressure-sensitive adhesive composition according to the present embodiment contains, as essential components, the aforementioned polymer (A) and (meth)acrylic polymer (B). The content of the (meth)acrylic polymer (B) is within a range of 0.05 parts by mass to 3 parts by mass, preferably within a range of 0.08 parts by mass to 2.5 parts by mass, and more preferably within a range of 0.1 parts by mass to 2 parts by mass, based on 100 parts by mass of the polymer (A). If more than 3 parts by mass of the (meth)acrylic polymer (B) is added, the transparency of the pressure-sensitive adhesive layer formed of the peelable acrylic pressure-sensitive adhesive composition according to the embodiment is deteriorated. Conversely, if less than 0.05 parts by mass of the (meth)acrylic polymer (B) is added, the high-speed peeling force in which the pressure-sensitive adhesive force occurring at high-speed peeling is small and the low-speed peeling force in which the adhesive force occurring at low-speed peeling is sufficiently so large as not to cause a problem, such as lifting and unintended separation, are not compatible with each other.

The peelable pressure-sensitive adhesive composition according to the present embodiment may contain, as optional components, various additives that are commonly used in the field of pressure-sensitive adhesive compositions, other than the aforementioned polymer (A) and (meth)acrylic polymer (B). A tackifying resin, cross-linking agent, catalyst, plasticizer, softener, filler, colorant (pigment, dye, or the like), antioxidant, leveling agent, stabilizer, antiseptic, and antistatic agent, etc., are exemplified as such optional components. Such additives that are conventionally and publicly known can be used by ordinary methods.

In order to adjust the cohesive force the later-described peelable pressure-sensitive adhesive layer, a cross-linking agent can also be used, other than the aforementioned polyfunctional monomers. Commonly-used cross-linking agents can be used as the cross-linking agent. Examples of the cross-linking agents include, for example: epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, isocyanate cross-linking agent, epoxy cross-linking agent, and metal chelate cross-linking agent can be preferably used. These compounds may be used alone or in combination of two or more thereof.

Specific examples of the isocyanate cross-linking agent include: tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane. Alternatively, a compound having, in one molecule, at least one isocyanate group and one or more unsaturated bonds, specifically 2-isocyanate ethyl(meth)acrylate, etc., can also be used as the isocyanate cross-linking agent. These compounds may be used alone or in combination of two or more thereof.

Examples of the epoxy cross-linking agent include: bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N′-diamine glycidyl aminomethyl)cyclohexane, etc. These compounds may be used alone or in combination of two or more thereof.

In the metal chelate compound, examples of the metal components include aluminum, iron, tin, titanium, and nickel, etc., and examples of the chelate components include acethylene, methyl acetoacetate, and ethyl lactate, etc. These compounds can be used alone or in combination of two or more thereof.

The content of the cross-linking agent to be used in the present embodiment is not particularly limited, but the cross-linking agent is usually used in an amount within a range of 0.01 parts by mass to 15 parts by mass, and preferably within a range of 0.5 parts by mass to 10 parts by mass, based on 100 parts by mass of the polymer (A). If the content thereof is less than 0.01 parts by mass, there are sometimes the cases where the cohesive force of the pressure-sensitive adhesive becomes small, and hence an adherend is contaminated. On the other hand, if the content is more than 15 parts by mass, there are sometimes the cases where the cohesive force of the polymer becomes large and the flowability thereof is deteriorated, and hence the wetting becomes insufficient, thereby causing the adhesiveness to be deteriorated.

The pressure-sensitive adhesive composition disclosed herein may further contain a cross-linking catalyst for effectively promoting anyone of the aforementioned cross-linking reactions. As such a cross-linking catalyst, for example, a tin catalyst (in particular, dibutyltindilaurate) can be preferably used. The use amount, of the cross-linking catalyst (e.g., tin catalyst, such as dibutyltin dilaurate) is not particularly limited, but the amount may be, for example, within a range of 0.005 parts by mass to 1 part by mass, based on 100 parts by mass of the polymer (A).

The pressure-sensitive adhesive composition disclosed herein may contain a compound that produces keto-enol tautomerism. For example, in the pressure-sensitive adhesive composition containing a cross-linking agent or in the pressure-sensitive adhesive composition that can be used by combining a cross-linking agent, an aspect in which the compound that produces keto-enol tautomerism is contained can be preferably adopted. Thereby, an excessive increase in the viscosity or gelling of the pressure-sensitive adhesive composition, possibly occurring after the combination of the cross-linking agent, can be suppressed and the effect of extending the pot-life of the composition can be achieved. When at least an isocyanate compound is used as the aforementioned cross-linking agent, it is particularly significant to contain the compound that produces keto-enoi tautomerism. This technique can be preferably adopted, when the aforementioned pressure-sensitive adhesive composition is, for example, in a form of an organic solvent solution or non-solvent solution.

Various β-dicarbonyl compounds can be used as the compound that produces the keto-enol tautomerism. Specific examples thereof include: β-diketones, such as acetylacetone, 2,4-hexanedione, 3,5-heptanedione, 2-methylhexane-3,5-dione, 6-methylheptane-2,4-dione, and 2,6-dimethylheptane-3,5-dione; acetoacetic esters, such as methyl acetoacetate, ethyl acetoacetate, isopropyl acetoacetate, tert-butyl acetoacetate; propionylacetic esters, such as ethyl propionylacetate, ethyl propionylacetate, isopropyl propionylacetate, and tert-butyl propionylacetate; isobutyrylacetic esters, such as ethyl isobutyrylacetate, ethyl isobutyrylacetate, isopropyl isobutyrylacetate, and tert-butyl isobutyrylacetate; and malonic esters, such as methyl malonate and ethyl malonate. Among them, acetylacetone and acetoacetic esters can be exemplified as preferred compounds. Such compounds that produce keto-enol tautomerism may be used alone or in combination of two or more thereof.

The use amount of a compound that produces keto-enol tautomerism may be, for example, within a range of 0.1 parts by mass to 20 parts by mass, and preferably within a range of 0.5 parts by mass to 15 parts by mass (e.g., within a range of 1 part by mass to 10 parts by mass), based on 100 parts by mass of the polymer (A). If the use amount of the compound is less than 0.1 parts by mass, there are sometimes the cases where it becomes difficult to exert the effect of using the compound. On the other hand, if the use amount thereof is more than 20 parts by mass, there are sometimes the cases where the compound remains in the pressure-sensitive adhesive layer and hence the cohesive force is decreased.

### [Peelable Pressure-Sensitive Adhesive Layer and Peelable Pressure-Sensitive Adhesive Sheet]

Subsequently, a peelable pressure-sensitive adhesive layer containing the peelable pressure-sensitive adhesive composition having the aforementioned composition, and a peelable pressure-sensitive adhesive sheet having the peelable pressure-sensitive adhesive layer, will be described.

The peelable pressure-sensitive adhesive layer can be a layer in which the peelable pressure-sensitive adhesive composition has been cured. That is, the pressure-sensitive adhesive layer can be formed by providing (e.g., applying, coating) the peelable pressure-sensitive adhesive composition to an appropriate supporting body and then by appropriately performing a cure treatment thereon. When the supporting body is a plastic substrate subjected to an antistatic treatment, the peelable pressure-sensitive adhesive layer can also be formed on the antistatic layer, alternatively can be formed on a surface that has not been subjected to an antistatic treatment. When two or more types of curing treatments (drying, cross-link formation are performed, these treatments can be performed simultaneously or in multiple stages. In the case of the pressure-sensitive adhesive composition in which a partial polymer (acrylic polymer syrup) has been used, a final copolymerization reaction is typically performed as the curing treatment (the partial polymer is subjected to a further copolymerization reaction to form a complete polymer). For example, in the case of a photo-curing pressure-sensitive adhesive composition, light radiation is performed. A curing treatment, such as cross-link formation, drying, or the like, may be performed, if necessary. For example, when a photo-curing pressure-sensitive adhesive composition needs to be dried, light radiation may be performed after the drying of the composition. In the case of the pressure-sensitive adhesive composition in which a complete polymer has been used, a treatment, such as drying (drying by heating), cross-link formation, or the like, is typically performed as the curing treatment, if necessary.

Application and coating of the peelable pressure-sensitive adhesive composition can be performed by using a commonly-used coater, such as, for example, a gravure roll coater, reverse roll coater, kiss roll coater, dip roll coater, bar coater, knife coater, spray coater, or the like. A pressure-sensitive adhesive layer may be formed by directly providing the pressure-sensitive adhesive composition to the supporting body, or a pressure-sensitive adhesive layer formed on a release liner may be transferred to the substrate.

In the present embodiment, the ratio of the solvent-insoluble component is within a range of 85.00% by mass to 99.95% by mass, preferably within a range of 90.00% by mass to 99.92% by mass, and more preferably within a range of 92.00% by mass to 99.90% by mass. If the ratio of the solvent-insoluble component is less than 85.00% by mass, the cohesive force becomes insufficient, and accordingly there are sometimes the cases where the sheet is contaminated when being peeled off from an adherend (object to be protected). Conversely, if the ratio thereof is more than 99.95% by mass, the cohesive force becomes too large, and accordingly there are sometimes the cases where the sheet is deteriorated in terms of sufficient pressure-sensitive adhesive force (high-speed peeling force, low-speed peeling force). A method of evaluating the ratio of the solvent-insoluble component will be described later.

The thickness of the peelable pressure-sensitive adhesive layer is not particularly limited, but is set to be usually, for example, within a range of 3 μm to 60 μm, and preferably within a range of 5 μm to 40 μm, thereby allowing good adhesiveness to be achieved. If the thickness of the pressure-sensitive adhesive layer is less than 3 μm, the adhesiveness becomes insufficient, and accordingly there are sometimes the cases where lifting and unintended separation is caused. On the other hand, if the thickness thereof is more than 60 μm, the high-speed peeling force becomes large, and accordingly there are sometimes the cases where the peeling workability is decreased.

The peelable pressure-sensitive adhesive sheet according to the present embodiment comprises a peelable pressure-sensitive adhesive layer made of the peelable pressure-sensitive adhesive composition. In the peelable pressure-sensitive adhesive sheet, such a pressure-sensitive adhesive layer is provided on at least one surface of the supporting body in a fixed manner, i.e., without an intention of separating the pressure-sensitive adhesive layer from the supporting body. The concept of the pressure-sensitive adhesive sheet described herein can involve objects referred to as a pressure-sensitive adhesive tape, pressure-sensitive adhesive film, and pressure-sensitive adhesive label, etc. The pressure-sensitive adhesive sheet may be cut into an appropriate shape, or may be subjected to a punching process, etc., in accordance with its use or application. The pressure-sensitive adhesive layer is not limited to one continuously formed, but may be one formed into a regular pattern, such as, for example, a dot shape and a stripe shape, or formed into a random pattern.

The aforementioned supporting body can be formed of a material appropriately selected, in accordance with the application of the pressure-sensitive adhesive tape, from the group consisting of, for example: plastic films including: polyolefin films, such as polyethylene, polypropylene, poly-1-butene, poly-4-methyl-1-penten, copolymer of ethylene/propylene, copolymer of ethylene/1-butene, copolymer of ethylene/vinyl acetate, copolymer of ethylene/ethyl acrylate, and copolymer of ethylene/vinyl alcohol; polyester films, such as polyethylene terephthalate, polyethylene naphthalate, and polybutylene terephthalate; polyamide films, such as polyacrylate film, polystyrene film, nylon 6, nylon 6,6, and partially aromatic polyamide; polyvinylchloride film; polyvinylidene chloride film; and polycarbonate film, etc.; foam substrates, such as polyurethane foam and polyethylene foam; paper, such as craft paper, crepe paper, and Japanese paper; cloth, such as cotton cloth and staple fiber cloth; nonwoven cloth, such as polyester nonwoven fabric and vinylon nonwoven fabric; metallic foils, such as aluminum foil and copper foil; and the like. When the peelable acrylic pressure-sensitive adhesive sheet according to the present embodiment is used as the later-described surface protective sheet, it is preferable to use a plastic film, such as a polyolefin film, polyester film, polyvinyl chloride film or the like, as the supporting body. In particular, when the acrylic pressure-sensitive adhesive sheet is used as an optical surface protective sheet, it is preferable to use a polyolefin film, polyethylene terephthalate film, polybutylene terephthalate film, or polyethylene naphthalate film. As the aforementioned plastic films, both of a non-oriented film and an oriented (uniaxially oriented or biaxially oriented) film can be used.

The supporting body may also be subjected to: a mold release treatment by a silicone mold release agent, fluorine mold release agent, long-chain alkyl mold release agent, fatty acid amide mold release agent, or silica powders; an anti-fouling treatment; and an adhesiveness-improving treatment, such as acid treatment, alkali treatment, primer treatment, corona treatment, plasma treatment, and ultraviolet treatment, if necessary. The thickness of the supporting body can be appropriately selected in accordance with its purpose, but is generally within a range of approximately 5 μm to approximately 200 μm (typically within a range of 10 μm to 100 μm).

The supporting body may also be subjected to: a mold release treatment by a silicone mold release agent, fluorine mold release agent, long-chain alkyl mold release agent, fatty acid amide mold release agent, or silica powders; an anti-fouling treatment; an adhesiveness-improving treatment, such as acid treatment, alkali treatment, primer treatment, corona treatment, plasma treatment, and ultraviolet treatment; and an antistatic treatment, such as coating type treatment, mixing type treatment, and deposition type treatment, if necessary.

A plastic film subjected to an antistatic treatment is more preferably used in the peelable pressure-sensitive adhesive sheet according to the present embodiment. By performing an antistatic treatment thereon, occurrence of static electricity can be prevented, and accordingly it is useful in the technical field related to optical and electronic components in which electrostatic charge poses a serious problem. The antistatic treatment to be performed on a plastic film is not particularly limited, but a method of providing an antistatic layer on at least one surface of the film or a method of mixing a mixing type antistatic agent into the plastic film, which is generally used, can be used. Examples of the method of providing an antistatic layer on at least one surface of the film include both a method of coating an antistatic resin made of an antistatic agent and a resin component, a conductive polymer, or a conductive polymer containing a conductive substance and a method of depositing or plating a conductive substance.

Examples of the antistatic agent contained in the antistatic resin include: cationic antistatic agents having a cationic functional group, such as a quaternary ammonium salt, pyridinium salt, or primary, secondary, or tertiary amino group; anionic antistatic agents having an anionic functional group, such as a sulfonate, sulfate ester salt, phosphonate salt, or phosphate ester salt; amphoteric antistatic agents, such as alkylbetaine and its derivatives, imidazoline and its derivatives, and alanine and its derivatives; nonionic antistatic agents, such as amino alcohol and its derivatives, glycerin and its derivatives, and polyethylene glycol and its derivative; and further ion conductive polymers obtained by polymerizing or copolymerizing a monomer having the aforementioned cationic, anionic, or amphoteric ion conductive group. These compounds may be used alone or in combination of two or more thereof.

Specific examples of the cationic antistatic agent include, for example: (meth)acrylate copolymers having a quaternary ammonium group, such as alkyl trimethyl ammonium salt, acyloylamidepropyltrimethyl ammonium methosulfate, alkylbenzyl methyl ammonium salt, acyl choline chloride, and polydimethylaminoethylmethacrylate; styrene copolymers having a quaternary ammonium group, such as poly vinylbenzyl trimethylammonium chloride; and diallylamine copolymers having a quaternary ammonium group, such as poly diallyldimethylammonium chloride. These compounds may be used alone or in combination of two or more thereof.

Specific examples of the anionic antistatic agent include, for example: alkylsulfonate salt, alkylbenzene sulfonate salt, alkylsulfate ester salt, alkylethoxysulfate ester salt, alkyl phosphate ester salt, and styrene copolymer containing a sulfonate group. These compounds may be used alone or in combination of two or more thereof.

Specific examples of the amphoteric antistatic agent include, for example: alkylbetaine, alkylimidazoliumbetaine and carbobetaine graft copolymer. These compounds may be used alone or in combination of two or more thereof.

Specifc examples of the nonionic antistatic agent include, for example: fatty acid alkylol amide, di(2-hydroxyethyl)alkylamine, polyoxyethylene alkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylene diamine, copolymer made of polyether, polyester, and polyamide, and methoxy polyethylene glycol(meth)acrylate, etc. These compounds may be used alone or in combination of two or more thereof.

Specific examples of the conductive polymer include, for example, polyaniline, polypyrrole, polythiophene, etc.

Specific examples of the conductive substance include, for example: tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and their alloys or mixtures.

General-purpose resins, such as polyester, acrylic, polyvinyl, urethane, melamine, and epoxy, are used as the resin component to be used in the antistatic resin and conductive resin. In the case of the polymeric antistatic agent, the resin component may not be contained. Alternatively, a melamine-based, urea-based, glyoxal-based, or acrylamide-based compound, which has been converted to methylol or alkylol, epoxy compound, or isocyanate compound may be contained in the antistatic resin component as a cross-linking agent.

The antistatic layer can be formed, for example, by a method in which the aforementioned antistatic resin, conductive polymer, or conductive resin is diluted with a solvent, such as an organic solvent or water, and the solution is coated on a plastic film and dried.

Examples of the organic solvent to be used for forming the antistatic layer include, for example, methyl ethyl ketone, acetone, ethyl acetate, tetrahydrofuran, dioxane, cyclohexanone, n-hexane, toluene, xylene, methanol, ethanol, n-propanol, and isopropanol, etc. These solvents can be used alone or in combination of two or more thereof.

A publicly-known coating method can be appropriately used as the method of forming the antistatic layer. Specific examples of the method include, for example, a roll coat method, gravure coat method, reverse coat method, roll brush method, spray coat method, air knife coat method, and impregnation or curtain coat method.

The thickness of the antistatic resin layer, conductive polymer layer, or conductive resin layer, is usually within a range of approximately 0.01 μm to approximately 5 μm, and preferably within a range of approximately 0.03 μm to approximately 1 p.m.

Examples of the method of depositing or plating the conductive substance include, for example, vacuum deposition, sputtering, ion plating, chemical deposition, spray pyrolysis, chemical plating, and electroplating method, etc.

The thickness of the conductive substance layer is usually within a range of 2 nm to 1000 nm, and preferably within a range of 5 nm to 500 nm.

The aforementioned antistatic agents are appropriately used as the mixing type antistatic agent. The combination amount of the antistatic agent is less than or equal to 20% by mass, and preferably within a range of 0.05% by mass to 10% by mass, based on the total mass of the plastic film. A method of mixing the antistatic agent is not particularly limited, as far as the agent can be uniformly mixed into the resin to be used in the plastic film; and, for example, a heating roll, Banbury mixer, pressurizing kneader, or twin screw kneader, can be used.

A release liner can be attached, if necessary, to the surface of the pressure-sensitive adhesive layer in the peelable pressure-sensitive adhesive sheet according to the present embodiment or in the later-described surface protective sheet and optical surface protective sheet, in order to protect the pressure-sensitive adhesive surface.

Paper or a plastic film is used as a material that forms the release liner; however, a plastic film is preferably used from the viewpoint of being excellent in surface smoothness. The film is not particularly limited, as far as the film can protect the pressure-sensitive adhesive layer. Examples of the film include, for example, a polyethylene film, polypropylene film, polybutene film, polybutadiene film, polymethylpentene film, polyvinylchloride film, vinyl chloride copolymer film, polyethylene terephthalate film, polybutylene terephthalate film, polyurethane film, and ethylene-vinylacetate copolymer film, etc.

The thickness of the release liner is usually within a range of approximately 5 μm to approximately 200 μm, and preferably within a range of approximately 10 μm to approximately 100 μm. It is preferable because the workability in attaching to the pressure-sensitive adhesive layer and that in peeling off therefrom are both excellent when the thickness is within the aforementioned range. The release liner may also be subjected to: a mold release treatment by a silicone mold release agent, fluorine mold release agent, long-chain alkyl mold release agent, fatty acid amide mold release agent, or silica powders; an anti-fouling treatment; and an antistatic treatment, such as coating type treatment, mixing type treatment, and deposition type treatment, if necessary.

The peelable pressure-sensitive adhesive sheet according to the present embodiment has the property that the pressure-sensitive adhesive force occurring at high-speed peeling is small and that the adhesive force occurring at low-speed peeling is sufficiently so large as not to cause a problem, such as lifting and unintended separation. The pressure-sensitive adhesive force of the peelable pressure-sensitive adhesive sheet according to the embodiment, occurring at high-speed peeling, can be evaluated by a 180°-peeling off pressure-sensitive adhesive force test performed under the conditions in which the sheet is peeled off at a tension speed of 30 m/min and a peeling angle is 180°. The pressure-sensitive adhesive force smaller than or equal to 2.5 N/25 mm is particularly determined to be good. The 180°-peeling off pressure-sensitive adhesive force is preferably smaller than or equal to 2.2 N/25 mm, and more preferably smaller than or equal to 2.0 M/25 mm. The minimum of the force is not particularly demanded, but is usually larger than or equal to 0.1 N/25 mm, and preferably larger than or equal to 0.2 N/25 mm. The 180°-peeling off pressure-sensitive adhesive force test is performed according to the method and conditions described in the later-described Examples.

The pressure-sensitive adhesive force of the peelable pressure-sensitive adhesive sheet according to the present embodiment, occurring at low-speed peeling, can be evaluated as a time necessary for the peeling in a constant load peeling test; and is determined to be good when the peeling time, occurring when a constant load of 1.2 g is applied, in the 90° direction, to the sheet sample having a size of 10 mm in width×50 mm in length, is 350 seconds or longer. The peeling time in the constant load peeling test is preferably 400 seconds or longer, and more preferably 450 seconds or longer. The maximum of the peeling time in the test is not particularly demanded, but is usually 950 seconds or shorter. The constant load peeling test is performed according to the method and conditions described in the later-described Examples.

The peelable pressure-sensitive adhesive sheet according to the present embodiment has the property of having high transparency. The transparency of the sheet can be evaluated by a haze, and is particularly determined to be good when a haze is less than 10%. The haze is preferably less than 5%, and more preferably less than 3.5%. A haze measurement is performed according to the method and conditions described in the later-described Examples.

### [Surface Protective Sheet]

It is preferable to use the peelable pressure-sensitive adhesive sheet according to the present embodiment as a surface protective sheet for protecting the surfaces of various objects to be protected, because the sheet has the property that the pressure-sensitive adhesive force occurring at high-speed peeling is small and that the adhesive force occurring at low-speed peeling is sufficiently so large as not to cause a problem, such as lifting and unintended separation, as stated above. Examples of the objects to be protected, to which the surface protective sheet according to the embodiment can be applied, include: various resins, such as PE (polyethylene), PP (polypropylene), ABS (acrylonitrile-butadiene-styrene copolymer), SBS (styrene-butadiene-styrene block copolymer), PC (polycarbonate), PVC (vinyl chloride), and acrylic resin, such as PMMA (polymethyl methacrylate resin); and automobiles (their body coatings), housing and building materials, and home electronic appliances, in which components made of metals, such as SUS (stainless steel) and aluminum, and glass, etc., are used.

When the peelable pressure-sensitive adhesive sheet according to the present embodiment is used as a surface protective sheet, the aforementioned peelable pressure-sensitive adhesive sheet can be used as it is. However, when the sheet is used particularly as a sheet for protecting surfaces, it is preferable, from the viewpoint of preventing the occurrence of scratches and stains and processability, that a polyolefin film, polyester film, or polyvinyl chloride film each having a thickness within a range of 10 μm to 100 μm, is used as the supporting body. It is also preferable the thickness of the pressure-sensitive adhesive layer is made to be within a range of approximately 3 μm to approximately 60 μm.

### [Optical Surface Protective Sheet]

It is further preferable to use the surface protective sheet according to the present embodiment as an optical surface protective sheet to be used for protecting the surface of an optical film, because the sheet according to the embodiment has the property of having high transparency in addition to the aforementioned pressure-sensitive adhesive property. Examples of the optical film, to which the optical surface protective sheet according to the embodiment can be applied, include a polarizing plate, wavelength plate, optical compensation film, light diffusing sheet, reflective sheet, anti-reflection sheet, brightness enhancement film, and transparent conductive film (ITO film), etc., which are to be used in image display devices, such as a liquid crystal display, plasma display, organic EL display.

The optical surface protective sheet according to the present embodiment can be used for: protecting optical films when they are shopped in a manufacturer of optical films, such as the aforementioned polarizing plates; protecting optical films when display devices (liquid crystal display modules) are manufactured in a manufacturer of image display devices, such as liquid crystal display devices; and further protecting optical films in various processes, such as punching process and cutting process.

When the peelable pressure-sensitive adhesive sheet according to the present embodiment is used as an optical surface protective sheet, the aforementioned peelable pressure-sensitive adhesive sheet can be used as it is. However, when the sheet is used particularly as a sheet for protecting optical surfaces, it is preferable, from the viewpoint of preventing the occurrence of scratches and stains, processability, and transparency, that a polyolefin film, polyethylene terephthalate film, polybutylene terephthalate film, or polyethylene naphthalate film each having a thickness within a range of 10 μm to 100 μm, is used as the supporting body. It is also preferable the thickness of the pressure-sensitive adhesive layer is made to be within a range of approximately 3 μm to approximately 40 μm.

[Optical Film with Surface Protective Sheet]

Another embodiment of the present invention is an optical film with a surface protective sheet in which an optical surface protective sheet is attached to the aforementioned optical film. The optical film with a surface protective sheet according to the embodiment is made by attaching the optical surface protective sheet to one or both surfaces of the optical film. The optical film with a surface protective sheet according to the embodiment can prevent the occurrence of scratches or the adhesion of dirt or dust in/to optical films, occurring: when the optical films are shipped in an manufacturer of optical films, such as the aforementioned polarizing plates; when display devices (liquid crystal display modules) are manufactured in a manufacturer of image display devices, such as liquid crystal display devices; and further in various processes, such as punching process and cutting process. The optical sheet with a surface protective sheet can be inspected as it is, because the optical surface protective sheet has high transparency. Further, when it becomes unnecessary, the optical surface protective sheet can be easily peeled off without damaging the optical film or image display device.

As stated above, the peelable pressure-sensitive adhesive composition according to the present embodiment comprises, as pressure-sensitive adhesive compositions: 100 parts by mass of the polymer (A) having a glass transition temperature lower than 0° C.; and 0.05 parts by mass to 3 parts by mass of the (meth)acrylic polymer (B) that has a weight average molecular weight of 1000 or more and less than 30000 and that contains, as a monomer unit, a (meth)acrylic monomer having an alicyclic structure. Thereby, when a pressure-sensitive adhesive layer is formed by using the composition, the pressure sensitive adhesive force occurring at high-speed peeling can be made small; the adhesive force occurring at low-speed peeling can be made sufficiently so large as not to cause a problem, such as lifting and unintended separation; and in particular, the transparency can be improved. From these excellent properties, the peelable pressure-sensitive adhesive sheet in which a peelable pressure-sensitive adhesive layer, made of the peelable pressure-sensitive adhesive composition according to the embodiment, is provided on a supporting body can be used as a surface protective sheet, and in particular, can be preferably used as an optical film surface protective sheet to be used for protecting the surface of an optical film. Further, the peelable pressure-sensitive adhesive sheet can also be used in an optical film with a surface protective sheet in which an optical surface protective sheet is attached to the optical film.

As the reason why, in the peelable pressure-sensitive adhesive sheet, the pressure-sensitive adhesive force occurring at high-speed peeling can be made small and the adhesive force occurring at low-speed peeling can be made sufficiently so large as not to cause a problem, such as lifting and unintended separation, without deterioration of the transparency, it is assumed that, by adding a (meth)acrylic polymer containing, as a monomer unit, a (meth)acrylic monomer having an alicyclic structure and by making the number of the added parts thereof to be small, the interfacial adhesiveness, which has a large influence on the pressure-sensitive adhesive force occurring at low-speed peeling, can be enhanced without a change in the physical properties of the bulk, which has a large influence on the pressure-sensitive adhesive force at high-speed peeling.

### EXAMPLES

Hereinafter, the present invention will be described in detail based on Examples, but the invention should not be limited at all by the Examples.

### (Preparation of Acrylic Polymer (A) (2EHA/HEA=96/4)

After 94 parts by mass of acrylic acid 2-ethylhexyl (2EHA), 4 parts by mass of acrylic acid 2-hydroxyethyl (HEA), 0.2 parts by mass of 2,2′-azobisisobutyronitrile, as a polymerization initiator, and 150 parts by mass of ethyl acetate were placed in a 4-neck flask provided with an impeller, thermometer, nitrogen gas inlet pipe, cooler, and dropping funnel, nitrogen gas was introduced while they were being stirred gently. The liquid temperature in the flask was maintained at approximately 65° C. and a polymerization reaction was performed for 6 hours to prepare the acrylic polymer (A) solution (40% by mass). The glass transition temperature of the acrylic polymer (A), calculated from Fox Equation, was −68° C. and the weight average molecular weight thereof was 550,000.

### (Preparation of (Meth)Acrylic Polymer 1 (DCPMA=100) as (B) Component)

One hundred parts by mass of toluene, 100 parts by mass of dicyclopentanyl methacrylate (DCPMA) (product name: FA-513M, made by Hitachi Chemical Co., Ltd.), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 1 to be obtained. The glass transition temperature of the obtained (meth)acrylic polymer 1 was 175° C. and the weight average molecular weight thereof was 4600.

### (Preparation of (Meth)Acrylic Polymer 2 (DCPMA=100) as (B) Component)

One hundred parts by mass of toluene, 100 parts by mass of dicyclopentanyl methacrylate (DCPMA) (product name: FA-513M, made by Hitachi Chemical Co., Ltd.), and 5 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 75° C. for 1 hour, 0.2 parts by mass of azobisisobutyronitrile were placed therein as a thermal polymerization initiator to react with them at 75° C. for 2 hours, and subsequently they were reacted together at 80° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 2 to be obtained. The glass transition temperature of the obtained (meth)acrylic polymer 2 was 175° C. and the weight average molecular weight thereof was 3000.

### (Preparation of (Meth)Acrylic Polymer 3 (DCPMA/MMA=40/60) as (B) Component)

One hundred parts by mass of toluene, 40 parts by mass of dicyclopentanyl methacrylate (DCPMA) (product name: FA-513M, made by Hitachi Chemical Co., Ltd.), 60 parts by mass of methyl methacrylate (MMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 3 hours, and subsequently they were reacted together at 80° C. for 3 hours. Thereafter, the reaction liquid was placed under a temperature atmosphere of 130° C. to dry and remove the toluene, chain transfer agent, and unreacted monomer, thereby allowing a solid (meth)acrylic polymer 3 to be obtained. The glass transition temperature of the obtained (meth)acrylic polymer 3 was 130° C. and the weight average molecular weight thereof was 5100.

### (Preparation of (Meth)Acrylic Polymer 4 (DCPMA/NVP=60/40) as (B) Component)

One hundred parts by mass of toluene, 60 parts by mass of dicyclopentanyl methacrylate (DCPMA) (product name: FA-513M, made by Hitachi Chemical Co., Ltd.), 40 parts by mass of N-vinylpyrrolidone, and 2 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 4 to be obtained. The glass transition temperature of the obtained (meth)acrylic polymer 4 was 117° C. and the weight average molecular weight thereof was 24000.

### (Preparation of (Meth)Acrylic Polymer 5 (DCPMA/HEMA=80/20) as (B) Component)

One hundred parts by mass of toluene, 80 parts by mass of dicyclopentanyl methacrylate (DCPMA) (product name: FA-513M, made by Hitachi Chemical Co., Ltd.), 20 parts by mass of hydroxyethyl methacrylate (HEMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 5 to be obtained. The glass transition temperature of the obtained (meth)acrylic polymer 5 was 139° C. and the weight average molecular weight thereof was 5500.

### (Preparation of (Meth)Acrylic Polymer 6 (DCPMA/MMA=60/40) as (B) Component)

One hundred parts by mass of toluene, 60 parts by mass of dicyclopentanyl methacrylate (DCPMA) (product name: FA-513M, made by Hitachi Chemical Co., Ltd.), 40 parts by mass of methyl methacrylate (MMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 3 hours, and subsequently they were reacted together at 80° C. for 3 hours. Thereafter, the reaction liquid was placed under a temperature atmosphere of 130° C. to dry and remove the toluene, chain transfer agent, and unreacted monomer, thereby allowing a solid (meth)acrylic polymer 6 to be obtained. The glass transition temperature of the obtained (meth)acrylic polymer 6 was 144° C. and the weight average molecular weight thereof was 4600.

### (Preparation of (Meth)Acrylic Polymer 7 (DCPMA/MMA=80/20) as (B) Component)

One hundred parts by mass of toluene, 80 parts by mass of dicyclopentanyl methacrylate (DCPMA) (product name: FA-513M, made by Hitachi Chemical Co., Ltd.), 20 parts by mass of methyl methacrylate (MMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 4 hours. Thereafter, the reaction liquid was placed under a temperature atmosphere of 130° C. to dry and remove the toluene, chain transfer agent, and unreacted monomer, thereby allowing a solid (meth)acrylic polymer 7 to be obtained. The glass transition temperature of the obtained (meth)acrylic polymer 7 was 159° C. and the weight average molecular weight thereof was 4200.

### (Preparation of (Meth)Acrylic Polymer 8 (IBXMA/MMA=40/60) as (B) Component)

One hundred parts by mass of toluene, 40 parts by mass of isobornyl methacrylate (IBXMA), 60 parts by mass of methyl methacrylate (MMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 8 to be obtained. The glass transition temperature of the obtained (meth)acrylic polymer 8 was 130° C. and the weight average molecular weight thereof was 4300.

### (Preparation of (Meth)Acrylic Polymer 9 (CHMA/IBMA=60/40) as (B) Component)

Sixty parts by mass of cyclohexyl methacrylate (CHMA), 40 parts by mass of isobutyl methacrylate (IBMA), and 4 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, they were heated to 90° C. and 0.005 parts by mass of a thermal polymerization initiator (product name: “PERHEXYL O”, made by NOF CORPORATION) and 0.01 parts by mass of a thermal polymerization initiator (product name: “PERHEXYL D”, made by NOF CORPORATION) were mixed. After being further stirred at 90° C. for 1 hour, the mixture was heated to 150° C. in 1 hour and stirred at the temperature for 1 hour. Subsequently, the mixture was heated to 170° C. in 1 hour and stirred at the temperature for 60 minutes. The pressure under which the mixture was placed was reduced at the temperature and the mixture was stirred for 1 hour to remove remaining monomers, thereby allowing (meth)acrylic polymer 9 to be obtained. The glass transition temperature of the obtained (meth)acrylic polymer 9 was 59° C. and the weight average molecular weight thereof was 4000.

### (Preparation of (Meth)Acrylic Polymer 10 (DCPMA/MMA=60/40) as (B) Component)

One hundred parts by mass of toluene, 60 parts by mass of dicyclopentanyl methacrylate (DCPMA) (product name: FA-513M, made by Hitachi Chemical Co., Ltd.), 40 parts by mass of methyl methacrylate (MMA), and 3 parts by mass of methyl thioglycolate, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 3 hours and further at 90° C. for 1 hour. Thereafter, the reaction liquid was placed under a temperature atmosphere of 130° C. to dry and remove the toluene, chain transfer agent, and unreacted monomer, thereby allowing a solid (meth)acrylic polymer 10 to be obtained. The glass transition temperature of the obtained (meth)acrylic polymer 10 was 144° C. and the weight average molecular weight thereof was 4400.

### (Preparation of (Meth)Acrylic Polymer 11 (DCPMA/MMA=60/40) as (B) Component)

One hundred parts by mass of ethyl acetate, 60 parts by mass of dicyclopentanyl methacrylate (DCPMA) (product name: FA-513M, made by Hitachi Chemical Co., Ltd.), 40 parts by mass of methyl methacrylate (MMA), and 3.5 parts by mass of α-thioglycerol, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 3 hours and further at 90° C. for 1 hour. Thereafter, the reaction liquid was placed under a temperature atmosphere of 130° C. to dry and remove the toluene, chain transfer agent, and unreacted monomer, thereby allowing a solid (meth)acrylic polymer 11 to be obtained. The glass transition temperature of the obtained (meth)acrylic polymer 11 was 144° C. and the weight average molecular weight thereof was 4300.

### (Preparation of (Meth)Acrylic Polymer 12 (DCPMA/MMA=60/40) as (B) Component)

One hundred parts by mass of toluene, 60 parts by mass of dicyclopentanyl methacrylate (DCPMA) (product name: FA-513M, made by Hitachi Chemical Co., Ltd.), 40 parts by mass of methyl methacrylate (MMA), and 6 parts by mass of laurylmercaptan, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 3 hours, and subsequently they were reacted together at 80° C. for 2 hours and further at 90° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 12 to be obtained. The glass transition temperature of the obtained (meth)acrylic polymer 12 was 144° C. and the weight average molecular weight thereof was 4200.

### (Preparation of (Meth)Acrylic Polymer 13 (DCPMA/MMA=60/40) as (B) Component)

One hundred parts by mass of ethyl acetate, 60 parts by mass of dicyclopentanyl methacrylate (DCPMA) (product name: FA-513M, made by Hitachi Chemical Co., Ltd.), 40 parts by mass of methyl methacrylate (MMA), and 0.35 parts by mass of α-thioglycerol, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 5 hours and further at 90° C. for 2 hours. Thereafter, the reaction liquid was placed under a temperature atmosphere of 130° C. to dry and remove the toluene, chain transfer agent, and unreacted monomer, thereby allowing a solid (meth)acrylic polymer 12 to be obtained. The glass transition temperature of the obtained (meth)acrylic polymer 13 was 144° C. and the weight average molecular weight thereof was 33000.

### (Preparation of (Meth)Acrylic Polymer 14 (MMA=100) as (B) Component)

One hundred parts by mass of toluene, 100 parts by mass of methyl methacrylate (MMA), and 3 parts by mass of thioglycolic acid, as a chain transfer agent, were placed into a 4-neck flask provided with an impeller, thermometer, nitrogen gas inlet pipe, cooler, and dropping funnel. After they were stirred under a nitrogen atmosphere at 70° C. for 1 hour, 0.2 parts by mass of azobisisobutyronitrile were placed therein as a thermal polymerization initiator to react with them at 70° C. for 2 hours, and subsequently they were reacted together at 80° C. for 4 hours. Thereafter, the reaction liquid was placed under a temperature atmosphere of 130° C. to dry and remove the toluene, chain transfer agent, and unreacted monomer, thereby allowing a solid (meth)acrylic polymer 14 to be obtained. The glass transition temperature of the obtained (meth)acrylic polymer 14 was 105° C. and the weight average molecular weight thereof was 4400.

### Example 1

### Preparation of Pressure-Sensitive Adhesive Composition

To 500 parts by mass of a solution (acrylic polymer (A): 100 parts by mass) that has been diluted, with ethyl acetate, to 20% by mass from the acrylic polymer (A) solution (35% by mass), 1 part by mass of the (meth)acrylic polymer 1, 4 parts by mass of an isocyanurate body of hexamethylene diisocyanate (product name: Coronate HX, made by Nippon Pol urethane Industry Co., Ltd.) and parts by mass of dibutyltin (1% by ma Qs et acetate solution), as a cross-linking catalyst, were added and they were mixed and stirred at 25° C. for approximately 5 minutes to prepare a pressure-sensitive adhesive composition

### (Production of Pressure-Sensitive Adhesive Sheet)

The aforementioned pressure-sensitive adhesive composition (1) was coated on the surface of a polyethylene terephthalate film with an antistatic treatment layer (product name: Diafoil T100G38, made by Mitsubishi Plastics Inc., thickness: 38 μm), the surface being located opposite to the surface on which an antistatic treatment is performed. The coated composition was heated at 130° C. for 2 minutes to form a pressure-sensitive adhesive layer having a thickness of 20 μm. Subsequently, the silicone-treated surface of a release liner (polyethylene terephthalate film having a thickness of 25 μm, one surface of which a silicone treatment is performed on) was attached to the surface of the aforementioned pressure-sensitive adhesive layer to produce a pressure-sensitive adhesive sheet.

### Example 2

### Preparation of Pressure-Sensitive Adhesive Composition

A pressure-sensitive adhesive composition (2) was prepared in the same way as in Example 1, except that 1 part by mass of the (meth)acrylic polymer 2 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (2) was used instead of the pressure-sensitive adhesive composition (1).

### Example 3

### Preparation of Pressure-Sensitive Adhesive Composition

A pressure-sensitive adhesive composition (3) was prepared in the same way as in Example 1, except that 0.1 parts by mass of the (meth)acrylic polymer 3 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (3) was used instead of the pressure-sensitive adhesive composition (1).

### Example 4

### Preparation of Pressure-Sensitive Adhesive Composition

A pressure-sensitive adhesive composition (4) was prepared in the same way as in Example 1, except that 1 part by mass of the (meth)acrylic polymer 3 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (4) was used instead of the pressure-sensitive adhesive composition (1).

### Example 5

### Preparation of Pressure-Sensitive Adhesive Composition

A pressure-sensitive adhesive composition (5) was prepared in the same way as in Example 1, except that 2 parts by mass of the (meth)acrylic polymer 3 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (5) was used instead of the pressure-sensitive adhesive composition (1).

### Example 6

### Preparation of Pressure-Sensitive Adhesive Composition

A pressure-sensitive adhesive composition (6) was prepared in the same way as in Example 1, except that 1 part by mass of the (meth)acrylic polymer (4) was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (6) was used instead of the pressure-sensitive adhesive composition (1).

### Example 7

### Preparation of Pressure-Sensitive Adhesive Composition

A pressure-sensitive adhesive composition (7) was prepared in the same way as in Example 1, except that 1 part by mass of the (meth)acrylic polymer (5) was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (7) was used instead of the pressure-sensitive adhesive composition (1).

### Example 8

### Preparation of Pressure-Sensitive Adhesive Composition

A pressure-sensitive adhesive composition (8) was prepared in the same way as in Example 1, except that 1 part by mass of the (meth)acrylic polymer (6) was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (8) was used instead of the pressure-sensitive adhesive composition (1).

### Example 9

### Preparation of Pressure-Sensitive Adhesive Composition

A pressure-sensitive adhesive composition (9) was prepared in the same way as in Example 1, except that 1 part by mass of the (meth)acrylic polymer (7) was used instead of 1 part by mass of the (meth)acrylic polymer 1 and 5.3 parts by mass of the isocyanurate body of hexamethylene diisocyanate (made by Nippon Polyurethane Industry Co Ltd., Coronate HX) was used instead of 4 parts by mass thereof.

### (Production of Pressure-Sensitive Adhesive Sheet)

A pressure-sensitive adhesive sheet was produced in the same way as in Example 1, except that the pressure-sensitive adhesive composition (9) was used instead of the pressure-sensitive adhesive composition (1).

### Example 10

### Preparation of Pressure-Sensitive Adhesive Composition

A pressure-sensitive adhesive composition (10) was prepared in the same way as in Example 1, except that 1 part by mass of the (meth)acrylic polymer 8 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (10) was used instead of the pressure-sensitive adhesive composition (1).

### Example 11

### Preparation of Pressure-Sensitive Adhesive Composition

A pressure-sensitive adhesive composition (11) was prepared in the same way as in Example 1, except that 1 part by mass of the (meth)acrylic polymer 9 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (11) was used instead of the pressure-sensitive adhesive composition (1).

### Example 12

### Preparation of Pressure-Sensitive Adhesive Composition

A pressure-sensitive adhesive composition (12) was prepared in the same way as in Example 1, except that 1 part by mass of the (meth)acrylic polymer 10 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (12) was used instead of the pressure-sensitive adhesive composition (1).

### Example 13

### Preparation of Pressure-Sensitive Adhesive Composition

A pressure-sensitive adhesive composition (13) was prepared in the same way as in Example 1, except that 1 part by mass of the (meth)acrylic polymer 11 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (13) was used instead of the pressure-sensitive adhesive composition (1).

### Example 14

### Preparation of Pressure-Sensitive Adhesive Composition

A pressure-sensitive adhesive composition (14) was prepared in the same way as in Example 1, except that 1 part by mass of the (meth)acrylic polymer 12 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (14) was used instead of the pressure-sensitive adhesive composition (1).

### Comparative Example 1

### Preparation of Pressure-Sensitive Adhesive Composition

A pressure-sensitive adhesive composition (15) was prepared in the same way as in Example 1, except that the (meth)acrylic polymer 1 was not used.

### (Production of Pressure-Sensitive Adhesive Sheet)

A pressure-sensitive adhesive sheet was produced in the same way as in Example 1, except that the pressure-sensitive adhesive composition (15) was used instead of the pressure-sensitive adhesive composition (1).

### Comparative Example 2

### Preparation of Pressure-Sensitive Adhesive Composition

A pressure-sensitive adhesive composition (16) was prepared in the same way as in Example 1, except that 5 parts by mass of the (meth)acrylic polymer 3 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (16) was used instead of the pressure-sensitive adhesive composition (1).

### Comparative Example 3

### Preparation of Pressure-Sensitive Adhesive Composition

A pressure-sensitive adhesive composition (17) was prepared in the same way as in Example 1, except that 1 part by mass of the (meth)acrylic polymer 13 was used instead of 1 part by mass of the (meth)acrylic polymer 1.

### (Production of Pressure-Sensitive Adhesive Sheet)

A pressure-sensitive adhesive sheet was produced in the same way as in Example 1, except that the pressure-sensitive adhesive composition (17) was used instead of the pressure-sensitive adhesive composition (1).

### Comparative Example 4

### Preparation of Pressure-Sensitive Adhesive Composition

A pressure-sensitive adhesive composition (18) was prepared in the same way as in Example 1, except that 1 part by mass of the (meth)acrylic polymer 14 was used instead of 1 part by mass of the (meth)acrylic polymer 1 and 5.3 parts by mass of the isocyanurate body of hexamethylene diisocyanate (product name: Coronate HX, made by Nippon Polyurethane Industry Co., Ltd.) was used instead of 4 arts by mass thereof.

### (Production of Pressure-Sensitive Adhesive Sheet)

A pressure-sensitive adhesive sheet was produced in the same way as in Example 1, except that the pressure-sensitive adhesive composition (18) was used instead of the pressure-sensitive adhesive composition (1).

The components of the pressure-sensitive adhesive compositions according to Examples 1 to 14 and Comparative Examples 1 to 4 are shown in Table 2.

TABLE 2

| | | (METH) ACRYLIC POLYMER (B) | | | | | RATIO OF SOLVENT- |
|---|---|---|---|---|---|---|---|
| | POLYMER (A) | | | | | NUMBER | INSOLUBLE |
| | COMPOSITION | | | MOLECULAR | | OF ADDED | COMPONENT |
| | (100 PARTS) | COMPOSITION | | WEIGHT | Tg(° C.) | PARTS | [%] |
| EXAMPLE 1 | 2EHA/HEA = 96/4 | DCPMA = | 100 | 4600 | 175 | 1 | 95.98 |
| EXAMPLE 2 | 2EHA/HEA = 96/4 | DCPMA = | 100 | 3000 | 175 | 1 | 96.14 |
| EXAMPLE 3 | 2EHA/HEA = 96/4 | DCPMA/MMA = | 40/60 | 5100 | 130 | 0.1 | 96.24 |
| EXAMPLE 4 | 2EHA/HEA = 96/4 | DCPMA/MMA = | 40/60 | 5100 | 130 | 1 | 96.00 |
| EXAMPLE 5 | 2EHA/HEA = 96/4 | DCPMA/MMA = | 40/60 | 5100 | 130 | 2 | 94.99 |
| EXAMPLE 6 | 2EHA/HEA = 96/4 | DCPMA/NVP = | 60/40 | 24000 | 117 | 1 | 96.31 |
| EXAMPLE 7 | 2EHA/HEA = 96/4 | DCPMA/HEMA = | 80/20 | 5500 | 139 | 1 | 96.18 |
| EXAMPLE 8 | 2EHA/HEA = 96/4 | DCPMA/MMA = | 60/40 | 4600 | 144 | 1 | 95.98 |
| EXAMPLE 9 | 2EHA/HEA = 96/4 | DCPMA/MMA = | 80/20 | 4200 | 159 | 1 | 95.90 |
| EXAMPLE 10 | 2EHA/HEA = 96/4 | IBXMA/MMA = | 40/60 | 4300 | 130 | 1 | 95.82 |
| EXAMPLE 11 | 2EHA/HEA = 96/4 | CHMA/IBMA = | 60/40 | 4000 | 59 | 1 | 96.62 |
| EXAMPLE 12 | 2EHA/HEA = 96/4 | DCPMA/MMA = | 60/40 | 4400 | 144 | 1 | 95.18 |
| EXAMPLE 13 | 2EHA/HEA = 96/4 | DCPMA/MMA = | 60/40 | 4300 | 144 | 1 | 96.04 |
| EXAMPLE 14 | 2EHA/HEA = 96/4 | DCPMA/MMA = | 60/40 | 4200 | 144 | 1 | 95.62 |
| COMPARATIVE | 2EHA/HEA = 96/4 | — | | — | — | — | 96.67 |
| EXAMPLE 1 | | | | | | | |
| COMPARATIVE | 2EHA/HEA = 96/4 | DCPMA/MMA = | 40/60 | 5100 | 130 | 5 | 92.60 |
| EXAMPLE 2 | | | | | | | |
| COMPARATIVE | 2EHA/HEA = 96/4 | DCPMA/MMA = | 60/40 | 33000 | 144 | 1 | 95.50 |
| EXAMPLE 3 | | | | | | | |
| COMPARATIVE | 2EHA/HEA = 96/4 | MMA = | 100 | 4400 | 105 | 1 | 95.43 |

EXAMPLE 4

The abbreviations in Table 2 represent the following compounds.
2EHA: Acrylic Acid 2-ethylhexyl
HEA: Acrylic Acid 2-hydroxyethyl
DCPMA: Dicyclopentanyl Methacrylate
MMA: Methyl Methacrylate
NVP: N-vinyl-2-pyrrolidone
HEMA: N-hydroxyethyl Methacrylate
IBXMA: Isobornyl Methacrylate
CHMA: Cyclohexyl Methacrylate
IBMA: Isobutyl Methacrylate

(Test method)

### <Measurement of Molecular Weight>

The weight average molecular weights of polymers and (meth)acrylic copolymers were measured by using a GPC apparatus (apparatus name: HLC-8220GPC, made by Tosoh Corporation). The measurement was performed under the following conditions and the molecular weight was determined in terms of polystyrene standard.
sample concentration: 0.2 wt % (tetrahydrofuran (THF) solution)
sample injection amount: 10 μl
eluent: THF
flow rate: 0.6 ml/min
measured temperature: 40° C.
columns:

sample column; TSK guard column Super HZ-H (1 column)+TSKgel Super HZM-H (2 columns)

reference column; TSKgel Super H-RC (1 column)
detector: differential refractometer (RI)

The (meth)acrylic copolymer 4 (DCPMA/NVP=60/40) was only measured in the following conditions.
sample concentration: 0.1 wt % (THF/N,N-dimethylformamide (DMF) solution)
sample injection amount: 20 μl
eluent: 10 mM-LiBr+10 mM-phosphoric acid/DMF
flow rate: 0.4 ml/min
measured temperature: 40° C.
columns:

sample column; TSK guard column Super AW-H (1 column)+TSKgel Super AWM-H+TSKgel Super AW4000+TSKgel Super AW2500 reference column; TSKgel Super H-RC (1 column)
detector: differential refractometer (RI)

### (Measurement of Ratio of Solvent-Insoluble Component)

A ratio of a solvent-insoluble component was determined in the following way: after 0.1 g of a pressure-sensitive adhesive layer was sampled and precisely weighed (mass before dipping), the sampled layer was dipped in approximately 50 ml of ethyl acetate at room temperature (20 to 25° C.) for 1 week; a solvent (ethyl acetate) insoluble portion was taken out to be dried at 130° C. for 2 hours and then weighed (mass after dipping and drying); and the aforementioned rate was calculated by using an equation for calculating the rate “solvent insoluble rate (mass %)=[(mass after dipping and drying)/(mass before dipping)]×100”.

### (Low-Speed Peeling Test “Constant Load Peeling”)

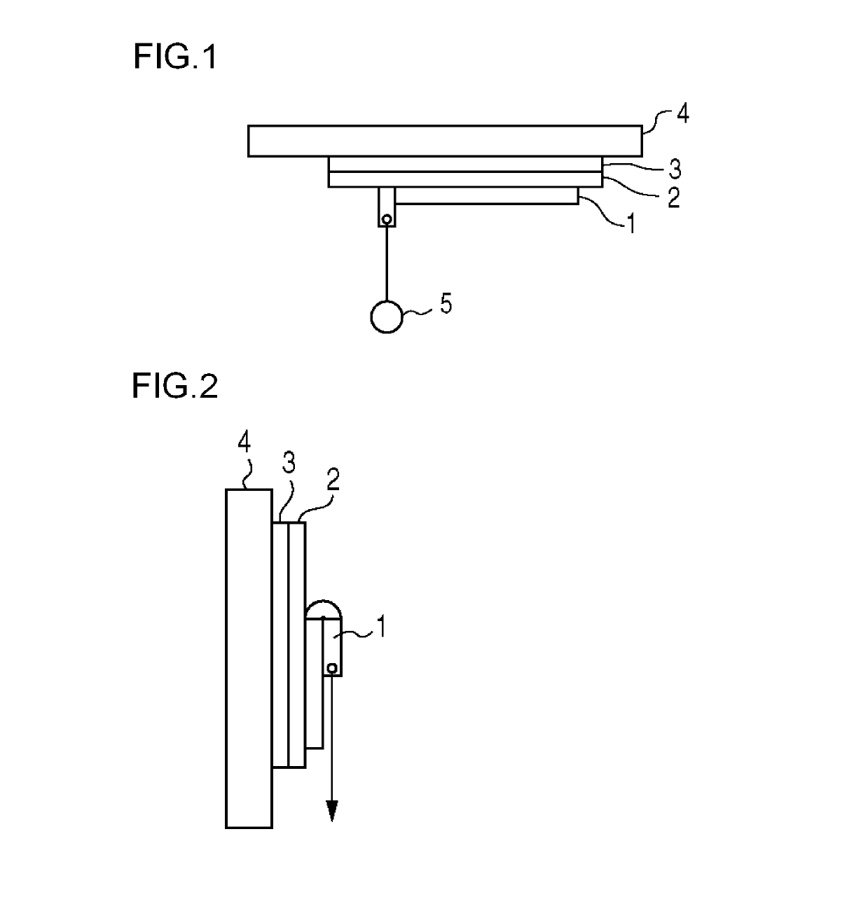

The pressure-sensitive adhesive sheet according to each of Examples and Comparative Examples was cut into a piece having a size of 10 mm in width×60 mm in length. After the release liner was peeled off, the sheet was pressure-bonded, with a hand roller, to the surface of a triacetyl cellulose polarizing plate (product name: SEG 1425 DU, made by NITTO DENKO CORPORATION, width: 70 mm, length: 100 mm) and then laminated under pressure-bonding conditions of 0.25 MPa and 0.3 m/min, thereby allowing an evaluation sample (optical film with a surface protective sheet) to be made. After the lamination, the sample was left uncontrolled under an environment of 23° C.×50% RH for 30 minutes. The other surface of the triacetyl cellulose polarizing plate 2 was fixed to an acrylic plate 4 with a double-sided pressure-sensitive adhesive tape 3, and a constant load 5 (1.2 g) was fixed to one end of the pressure-sensitive adhesive sheet 1, as illustrated in FIG. 1. Peeling of the tape sample was initiated with the constant load such that the peeling angle was 90°. The length of 10 mm was made to be an extra length and the time during which all of the remaining length of 50 mm was peeled off was measured. The measurement was performed under the condition of 23° C.×50% RH. The case where the peeling time under a constant load was 350 seconds or longer was evaluated as good, while the case where the peeling time was shorter than 350 seconds was evaluated as bad. Results of the measurement are shown in Table 3.

### (High-Speed Peeling Test “180°-Peeling Off Pressure-Sensitive Adhesive Force”)

The pressure-sensitive adhesive sheet according to each of Examples and Comparative Examples was cut into a piece having a size of 25 mm in width×100 mm in length. After the release liner was peeled off, the sheet was pressure-bonded, with a hand roller, to the surface of a triacetyl cellulose polarizing plate (product name: SEG 1425 DU, made by NITTO DENKO CORPORATION, width: 70 mm, length: 100 mm) and then laminated under pressure-bonding conditions of 0.25 MPa and 0.3 m/min, thereby allowing an evaluation sample (optical film with a surface protective sheet) to be made. After the lamination, the sample was left uncontrolled under an environment of 23° C.×50% RH for 30 minutes and the other surface of the triacetyl cellulose polarizing plate 2 was then fixed to an acrylic plate 4 with a double-sided pressure-sensitive adhesive tape 3. The pressure-sensitive adhesive force, occurring when one end of the pressure-sensitive adhesive sheet 1 was peeled off, with a versatile tensile tester, under conditions in which tensile speed was 30 m/min and a peeling angle was 180°, was measured. The measurement was performed under the condition of 23° C.×50% RH. The case where the pressure-sensitive adhesive force occurring at high-speed peeling was smaller than 2.5 N/25 mm was evaluated as good, while the case where the force was larger than or equal to 2.5 N/25 mm was as bad. Results of the measurement are shown in Table 3.

### (Transparency Test: Haze)

The pressure-sensitive adhesive sheet according to each of Examples and Comparative Examples was cut into a piece having a size of 50 mm in width×50 mm in length. After the release liner was peeled off, a haze was measured by using a haze meter (made by MURAKAMI COLOR RESEARCH LABORATORY Co., Ltd.). The case where the haze was less than 10% was evaluated as good, while the case where the haze was 10% or more was evaluated as bad. Results of the measurement are shown in table 3.

TABLE 3

| | | HIGH- | |
|---|---|---|---|
| | | SPEED | |
| | | PEELING | |
| | LOW- | TEST | |
| | SPEED | (180° PEELING- | |
| | PEELING | OFF | |
| | TEST | PRESSURE- | |
| | (CONSTANT | SENSITIVE | |
| | LOAD | ADHESIVE | |
| | PEELING) | FORCE) | TRANSPARENCY |
| | [sec] | [N/25 mm] | (HAZE) (%) |
| EXAMPLE 1 | 620 | 1.90 | 2.3 |
| EXAMPLE 2 | 645 | 1.81 | 2.2 |
| EXAMPLE 3 | 472 | 1.37 | 2.1 |
| EXAMPLE 4 | 795 | 1.53 | 2.5 |
| EXAMPLE 5 | 745 | 1.16 | 6.0 |
| EXAMPLE 6 | 505 | 1.61 | 3.6 |
| EXAMPLE 7 | 436 | 1.99 | 3.6 |
| EXAMPLE 8 | 869 | 1.77 | 2.3 |
| EXAMPLE 9 | 737 | 1.25 | 3.4 |
| EXAMPLE 10 | 634 | 1.48 | 2.5 |
| EXAMPLE 11 | 413 | 1.90 | 2.3 |
| EXAMPLE 12 | 866 | 2.25 | 2.2 |
| EXAMPLE 13 | 520 | 2.11 | 3.1 |
| EXAMPLE 14 | 679 | 2.09 | 2.1 |
| COM- | 274 | 1.70 | 2.1 |
| PARATIVE | | | |
| EXAMPLE 1 | | | |
| COM- | 970 | 1.20 | 12.2 |
| PARATIVE | | | |
| EXAMPLE 2 | | | |
| COM- | 319 | 1.50 | 3.2 |
| PARATIVE | | | |
| EXAMPLE 3 | | | |
| COM- | 341 | 1.13 | 5.5 |
| PARATIVE | | | |
| EXAMPLE 4 | | | |

It has been confirmed that, as shown in Table 3: in Comparative Example 1 in which the (meth)acrylic polymer (B), which has a weight average molecular weight of 1000 or more and less than 30000 and which contains, as a monomer unit, a (meth)acrylic monomer having an alicyclic structure, has not been used, the pressure-sensitive adhesive force occurring at low-speed peeling is not sufficient; and in Comparative Example 2 in which the (meth)acrylic polymer (B) has been added in an amount of 3 parts by mass or more, the transparency is remarkably deteriorated. It has also been confirmed that, in Comparative Example 3 in which the (meth)acrylic polymer (B) having a weight average molecular weight of 30000 or more has been used, the pressure-sensitive adhesive force occurring at low-speed peeling is not sufficient. It has also been confirmed that, in Comparative Example 4 in which the (meth)acrylic polymer (B), which does not contain a (meth)acrylic monomer having an alicyclic structure, has been used, the pressure-sensitive adhesive force occurring at low-speed peeling is not sufficient.

In each of Examples, the high-speed peeling property and low-speed peeling property have been both achieved and the transparency has also been good.

What is claimed is:

1. A peelable pressure-sensitive adhesive composition, comprising:
100 parts by mass of a polymer (A) having a glass transition temperature lower than 0° C.; and
0.05 parts by mass to 3 parts by mass of a (meth)acrylic polymer (B) that has a weight average molecular weight of 1000 or more and less than 30000 and that contains, as a monomer unit, a (meth)acrylic monomer having an alicyclic structure represented by the following general formula (1):
CH₂═C(R¹)COOR² (1)
[wherein, R¹ is a hydrogen atom or methyl group and R² is an alicyclic hydrocarbon group having an alicyclic structure].

2. The peelable pressure-sensitive adhesive composition according to claim 1, wherein
the polymer (A) is an acrylic polymer.

3. The peelable pressure-sensitive adhesive composition according to claim 1, wherein
the alicyclic hydrocarbon group having an alicyclic structure has a bridged ring structure.

4. The peelable pressure-sensitive adhesive composition according to claim 1, wherein
the glass transition temperature of the (meth)acrylic polymer (B) is within a range of 20° C. to 300° C.

5. A peelable pressure-sensitive adhesive layer made of the peelable pressure-sensitive adhesive composition according to claim 1.

6. The peelable pressure-sensitive adhesive layer according to claim 5 containing 85.00 to 99.95% by mass of a solvent-insoluble component.

7. A peelable pressure-sensitive adhesive sheet in which the peelable pressure-sensitive adhesive layer according to claim 5 is formed on at least one surface of a supporting body.

8. The peelable pressure-sensitive adhesive sheet according to claim 7, wherein
the supporting body is a plastic film on which an antistatic treatment is performed.

9. A surface protective sheet made of the peelable pressure-sensitive adhesive sheet according to claim 7.

10. An optical surface protective sheet to be used for protecting the surface of an optical film, which is made of the surface protective sheet according to claim 9.

11. An optical film with a surface protective sheet, to which the optical surface protective sheet according to claim 10 is attached.

12. The peelable pressure-sensitive adhesive composition according to claim 2, wherein
the alicyclic hydrocarbon group having an alicyclic structure has a bridged ring structure.

13. The peelable pressure-sensitive adhesive composition according to claim 2, wherein
the glass transition temperature of the (meth)acrylic polymer (B) is within a range of 20° C. to 300° C.

14. The peelable pressure-sensitive adhesive composition according to claim 3, wherein
the glass transition temperature of the (meth)acrylic polymer (B) is within a range of 20° C. to 300° C.

15. A peelable pressure-sensitive adhesive layer made of the peelable pressure-sensitive adhesive composition according to claim 2.

16. A peelable pressure-sensitive adhesive layer made of the peelable pressure-sensitive adhesive composition according to claim 3.

17. A peelable pressure-sensitive adhesive layer made of the peelable pressure-sensitive adhesive composition according to claim 4.

18. The peelable pressure-sensitive adhesive layer according to claim 15 containing 85.00 to 99.95% by mass of a solvent-insoluble component.

19. The peelable pressure-sensitive adhesive layer according to claim 16 containing 85.00 to 99.95% by mass of a solvent-insoluble component.

20. The peelable pressure-sensitive adhesive layer according to claim 17 containing 85.00 to 99.95% by mass of a solvent-insoluble component.
